(19) United States
(12) Patent Application Publication
(10) Pub. No.: US 2007/0160152 A1
(43) Pub. Date: Jul. 12, 2007

(54) System for encoding/decoding motion picture and method for encoding/decoding motion picture

(75) Inventor: Masahiko YOSHIMOTO, Hyogo (JP)

Correspondence Address: KANESAKA BERNER AND PARTNERS LLP, 1700 DIAGONAL RD, SUITE 310, ALEXANDRIA, VA, 22314-2848, US

(73) Assignee: Kanazawa University Technology Licensing Organization Ltd., Tokyo (JP)

(21) Appl. No.: 10/581,737

(22) PCT Filed: Dec. 8, 2004
(86) PCT No.: PCT/JP04/18312

§ 371 Date: Aug. 11, 2006

(30) Foreign Application Priority Data
Dec. 8, 2003 (JP) 2003-409641

(51) Int. Cl. H04N 7/12

(52) U.S. Cl. 375/240.26

(57) ABSTRACT

[Task] A motion picture encoding/decoding system and a motion picture encoding/decoding method which are capable of allowing decrease of power consumption are provided.

[Means of solution] The system and the method are severally provided with a processor 1, a means of calculating necessary operation volume 2 for calculating the volume of operation necessary for encoding/decoding the present frame, and a means of calculating power-supply voltage, substrate bias voltage and operating frequency 3 for calculating a power-supply voltage and a substrate bias voltage and an operating frequency which are capable of encoding/decoding the necessary operation volume within the time allocated in advance to the process of encoding/decoding the present frame. The processor 1 performs the process of encoding/decoding the present frame while operating steadily with the operating frequency and the power-supply voltage and the substrate bias voltage calculated as mentioned above.

### TECHNICAL FIELD

This invention relates to a system for encoding/decoding a motion picture, which system is capable of sequentially encoding/decoding the motion picture formed of a plurality of successive frames or decoding in the unit of frame by the use of a processor implemented with MOS transistors laminated on a semiconductor substrate and permitting the processor to control the operating frequency and the substrate bias voltage or the operating voltage, the substrate bias voltage, and the power-supply voltage, and a method for encoding/decoding the motion picture.

### BACKGROUND ART

In recent years, it has become feasible to transmit and receive a motion picture via a transmission line and accumulate the motion picture in an accumulation medium. Since the motion picture generally has a large volume of information, the technique for encoding/decoding the motion picture has been indispensable when the motion picture is transmitted by using a transmission line furnished with a limited transmission bit rate or when the motion picture is accumulated in an accumulation medium furnished with a limited capacity for accumulation. MPEG (Moving Picture Experts Group), whose standardization is now being promoted by ISO/IEC and H.26X, is an example of the method for encoding/decoding the motion picture. It is the technique for encoding/decoding a plurality of successive frames which form the motion picture, enabling the motion picture to be encoded in a decreased volume of information by curtailing the redundancy by virtue of the temporal relation and the spatial relation of the motion picture and decoding the encoded motion picture into the original motion picture.

The encoding/decoding technique mentioned above has been implemented on such information equipments as personal computers and portable telephones furnished with a built-in micro-computer. By actuating the processor in a computer with a prescribed program of encoding/decoding process, information equipments can function as a system for encoding a motion picture in the case of transmitting the motion picture or as a system for decoding the motion picture in the case of receiving the motion picture. Since the process for encoding/decoding the motion picture, however, tends to consume higher power consumption because it entails a comparatively large amount of operation, decreasing the power consumption in the encoding/decoding process by using software of higher flexibility than hardware has come to a big issue.

Now, the conventional means for decreasing the power consumption by the use of software in the system for encoding/decoding the motion picture will be described below. The conventional means for decreasing the power consumption is disclosed, for example, in the Non-Patent Document 1 identified below.

Non-Patent Document 1: “An LSI for VDD-Hopping and MPEG4 System Based on the Chip” (H. Kawaguchi, G. Zhang, S. Lee, and T. Sakurai) inserted in Collection of Summaries, pp 918-921, of IEEE International Symposium on Circuits and System 2001 (May, 2001).

FIG. 14 is a diagram that illustrates the conventional procedure for decreasing the power consumption effectively in a system for processing (encoding) a motion picture as disclosed in Non-Patent Document 1. Incidentally, this means of decreasing the power consumption applies identically to the system for decoding the motion picture.

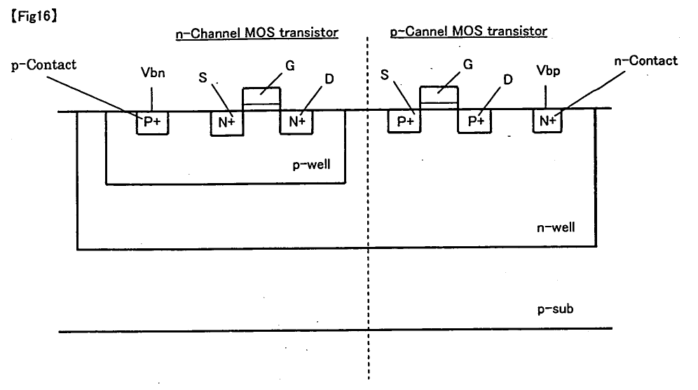

Non-Patent Document 1 depicts a method for controlling the power-supply voltage and the operating frequency for accomplishing the decrease of power consumption in the case of encoding the motion picture (particularly MPEG) on a processor which is capable of dynamically varying the power-supply voltage and the operating frequency. Alternatively mentioned, the invention of Non-Patent Document 1 is aimed at decreasing the power consumption by controlling the operating frequency and the power-supply voltage of the processor in due respect of the variation which is induced in the amount of operation of encoding/decoding the motion picture in the unit of frame as by the intensity of motion in the motion picture in the case of encoding the motion picture as illustrated in FIG. 15.

The encoding process has the time for processing one frame restricted to a time Tf as in accordance with the regulations of the method of encoding (such as MPEG) and is required to complete the encoding process of one frame within the duration of this processing time Tf. The processing time Tf (seconds) for one frame is divided at fixed intervals into N portions, the individual intervals (time) are defined as time slots Tslot (Tslot=Tf/N), and a residual time TRi after the elapse from the time slot Tslot 1 to the time slot Tslot i is defined as TRi=Tf−Tslot×i. The number of blocks of a motion picture to be processed in one time slot Tslot (the process for encoding the motion picture is carried out in the unit of block) is denoted as R (namely, the product R×N represents the number of blocks in one frame) and the time spent in processing (R×i) blocks (namely the time actually spent for processing the group of blocks to be processed from the time slot Tslot 1 through the time slot Tslot I) is denoted as Tacc (i+1). The time that elapses till the power-supply voltage and the operating frequency are stabilized in the case of varying voltage is denoted as Trd. Incidentally, a real time slot RTslot i represents the processing time actually required for the process that is to be completed within the time slot Tslot i. With reference to FIG. 14, for the processing of the group of blocks allocated first to the time slot Tslot 1 and a time slot Tslot 2, the relevant operation is actuated with a clock frequency fmax which is amply capable of completing the processing within the time slots Tslot 1 and Tslot 2 even under the maximum workload. When a time Tacc 3 spent for this processing answers the expression Tacc 3<(Tf−TR2), namely when the processing of the group of allocated blocks is completed within the time slots T slot 1 and T slot 2, since a processing time Ttar 3 which is usable for processing the group of blocks allocated to a subsequent time slot Tslot 3 answers the expression Ttar 3=Tf−Tacc 3−Tr 3−Trd and requires only to allow completion of the processing of the group of blocks allocated to the Tslot 3 within this processing time Ttar 3, the relevant operation performed on this group of blocks is actuated at a lowered operating frequency. Processing times Tf1, Tf2, and Tf3 shown in FIG. 14 represent the processing times spent during the relevant operations performed at respective operating frequencies f1, f2, and f3 when the time slot Tslot 3 has the largest workload. When the operating frequency f2=fmax/2 shown in FIG. 14 is selected as the operating frequency, the processing time required to terminate in the interval from the time slot Tslot 1 through the time slot Tslot 3 falls within (Tf−TR 3) and does not intrude on the subsequent time slot Tslot 4. Meanwhile, when the operating frequency f3=fmax/3 is selected, the processing time Tf 3 inevitably exceeds the processing time Ttar 3. For the group of blocks to be processed in this time slot Tslot 3, therefore, the relevant operation is performed at the operating frequency f2=fmax/2 and a power-supply voltage suitable for this operating frequency. In the same manner, this process is performed on each of the time slots Tslot.

On the occasion of dynamically varying the operating clock frequency and the power-supply voltage, therefore, the relevant operation can be performed invariably at a lower operating frequency and a lower power-supply voltage by selecting the smallest of the operating frequencies capable of processing a group of a prescribed the number of blocks within a prescribed duration of time and the decrease of power consumption can be attained by controlling the voltage in conformity with the necessary processing.

Incidentally, for the process (the process of one frame, for example) which is required to terminate within a fixed processing time (the processing time Tf for one frame, for example), it is preferred to effect the process by operating the processor at fixed power-supply voltage and operating frequency throughout the entire processing time for one frame. Specifically, by causing the processor to be operated at a fixed operating frequency Ff throughout the entire length of the processing time Tf of one frame under the conditions satisfying the expression Ff=Kf/Tf (cycles/second), wherein Tf denotes the processing time (second) for one frame, Kf for the amount of operation (cycle), and Ff for the operating frequency, it is made possible to attain the decrease of power consumption as compared with the case of having the operating frequency Ff vary many times within the processing time. The proof of this decrease in power consumption will appear in Proof 2 inserted in the first mode of embodiment cited herein below.

In Non-Patent Publication 1, however, though one frame constitutes the synchronizing unit of the processing time Tf, the power-supply voltage and the operating frequency are varied in up to N times within one frame, a fact which proves lack of due consideration to the reduction of power consumption. That is, the decrease of power consumption in the process for encoding/decoding the motion picture by the use of a processor capable of controlling the power-supply voltage and the operating frequency in may stages as in the conventional procedure has required the power-supply voltage and the operating frequency to be varied may times during the course of processing one frame. Since the frames individually constitute the unit for restricting the processing time as described above, it is preferable to control the processing of one frame at a fixed frequency of the lowest possible value which renders the processing feasible. The conventional procedure that suffers the power-supply voltage and the operating frequency to vary in up to N times during the course of processing one frame, therefore, has been unable to decrease sufficiently the power consumption.

### DISCLOSURE OF THE INVENTION

### Task to be Solved by the Invention

As another primary factor which impedes the decrease of power consumption by the processor, the subthreshold leakage current of the MOS transistor which partakes in the configuration of the processor may be cited. The subthreshold leakage current is a minute current that flows when the gate-to-source voltage of the MOS transistor formed on a semiconductor substrate is lower than the threshold voltage. The electric power consumed by this subthreshold leakage current tends to become predominant as MOS transistors are scaled down and constitutes one primary factor for impeding the decrease of power consumption in the system for encoding/decoding the motion picture by the use of a processor implemented with MOS transistors laminated on a semiconductor substrate.

This subthreshold leakage current can be decreased so much as to realize the decrease of power consumption in the processor by operating the processor at a fixed operating frequency Ff throughout the entire course of the processing time Tf as compared with the case of having the operating frequency Ff of the processor vary many times within the processing time Tf of one frame. The proof of this decrease of the power consumption will appear in Proof 1 inserted in the first mode of embodiment cited herein below. The invention of Non-Patent Document 1 mentioned above suffers the operating frequency to vary in up to N times within one frame, though one frame constitutes the synchronizing unit of the processing time Tf. Threfore, it proves to be disadvantageous from the viewpoint of not merely the power-supply voltage but also the subthreshold leakage current.

Meanwhile, as regards the MOS transistor, it has been known that the subthreshold leakage current can be controlled by regulating the substrate bias voltage of the semiconductor region in which the MOS transistor is formed.

The leakage current which flows in the processor consists of GIDL (Gate-Induced Drain Leakage), DIBL (Drain-Induced Barrier Lowering), gate leakage, and other electric currents besides the charging and discharging electric currents and the subthreshold leakage current. These electric currents tend to increase as MOS transistors are scaled down and constitute one factor for impeding the decrease of power consumption of the processor.

Thus, the present invention is aimed at solving the problems mentioned above and is directed toward providing a system for encoding/decoding a motion picture, which system is capable of decreasing the subthreshold leakage current, further permitting decrease of such electric currents as GIDL, DIBL, and gate leakage, and promoting effective decrease of power consumption, and a method for encoding/decoding the motion picture.

### MEANS FOR SOLUTION OF THE TANK

The present inventors, regarding the processor which is a semiconductor device implemented with MOS transistors laminated thereon, have been ascertained that the decrease of power consumption by the processor can be realized by regulating the substrate bias voltage consequently controlling the subthreshold leakage current. The method of controlling the substrate bias voltage and the effect of this control in decreasing the power consumption will be described in detail below. By the processor being formed on a triple-well structure, for example, it is made possible to control a substrate bias voltage Vbn of an n-channel MOS transistor, control a substrate bias voltage Vbp of a p-channel MOS transistor, and effect control of the substrate bias voltage.

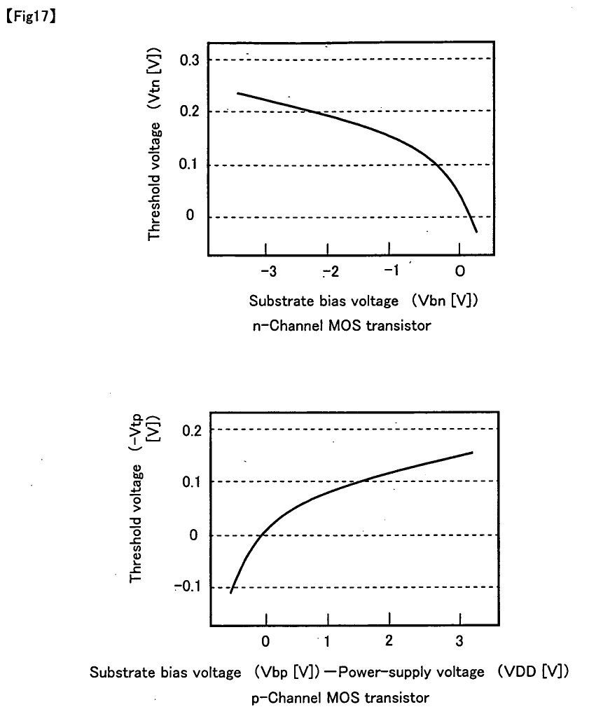

FIG. 16 is a partial cross section of a processor 1 in a triple-well structure. The processor 1 is formed on a triple-well structure by forming an n-type well named n-well in a p-type semiconductor substrate named p-sub and further forming a p-type well named p-well in the n-type well named n-well. In the p-type well named p-well, an n-channel MOS transistor and a p-type well contact layer named p-Contact are formed. The n-channel MOS transistor is furnished with a source/drain layer S, D formed of an n-type diffusion layer and a gate electrode G. In the n-type well named n-well, a P-channel MOS transistor and an n-type well contact layer n-Contact. The n-channel MOS transistor is furnished with a source/drain layer S, D formed of a p-type diffusion layer and a gate electrode G. To the p-type well named p-well in a semiconductor region allowing the n-channel MOS transistor to be formed therein, the substrate bias voltage Vbn is applied through the medium of the p-type well contact layer named p-Contact. To the n-type well named n-well in a semiconductor region allowing the p-channel MOS transistor to be formed therein, the substrate bias voltage Vbp is applied through the medium of the n-type well contact layer named n-Contact.

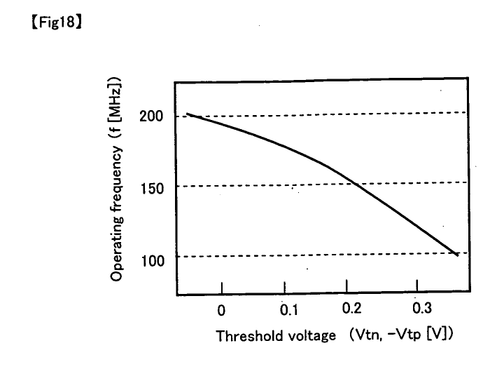

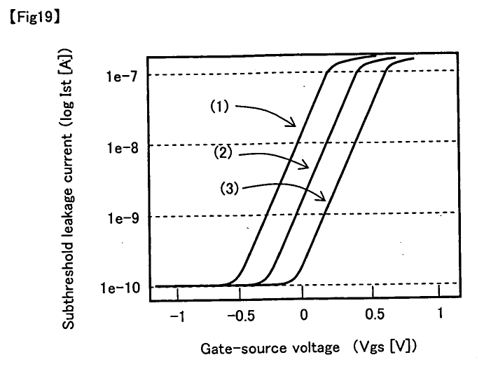

FIG. 17 represents an example of the relation between the substrate bias voltage Vbn and a threshold voltage Vtn of the n-channel MOS transistor, and an example of the relation between the substrate bias voltage Vbp and a threshold voltage Vtp of the p-channel MOS transistor. Since the threshold voltage Vtn falls when the substrate bias voltage Vbn of the n-channel MOS transistor rises and a threshold voltage −Vtp rises when the substrate bias voltage Vbp of the p-channel MOS transistor rises, the control of the threshold voltages Vtn and −Vtp can be obtained by varying the substrate bias voltages Vbn and Vbp. Since the operating frequency of the processor generally rises when the threshold voltages Vtn and −Vtp fall as shown in the example of FIG. 18, the variation of the operating frequency f of the processor 1 is obtained by controlling the threshold voltages. FIG. 19 represents examples of the relation between the threshold voltages Vtn and −Vtp and a subthreshold leakage current Ist; the line (1) depicting the case in which the Vtn and the −Vtp are each 0 [V], the line (1) the case in which the Vtn and the −Vtp are each 0.1 [V], and the line (3) the case in which the Vtn and the −Vtp are each 0.2 [V]. Since the subthreshold leakage current Ist falls when the threshold voltages Vtn and −Vtp rise as shown in FIG. 19, the subthreshold leakage current Ist can be controlled by regulating the threshold voltages Vtn and −Vtp. As a result, the subthreshold leakage current Ist can be controlled by the substrate bias voltages Vbn and Vbp. Thus, the operating frequency f can be realized by calculating an operating frequency f that fits the volume of operation and the subthreshold leakage current Ist can be repressed as well by controlling the substrate bias voltages Vbn and Vbp so as to attain necessary repression and performing the process of encoding/decoding one frame while keeping the processor operated steadily with that operating frequency f. When the operating frequency can be set on a low level, for example, the threshold voltage can be increased and the subthreshold leakage current can be repressed by lowering the substrate bias voltage. As a result, the total current can be repressed and the decrease of power consumption can be realized.

The present inventors have been enabled by controlling the substrate bias voltage in accordance with the foregoing results to perfect this invention which is directed toward repressing the subthreshold leakage current and realizing the decrease of power consumption.

Specifically, the method/system of this invention for encoding/decoding a motion picture concerns a motion picture encoding/decoding system/method, which incorporates a means/step of encoding/decoding motion picture for sequentially encoding/decoding in the unit of frame a motion picture formed of a plurality of successive frames by the use of a processor implemented with MOS transistors laminated on a semiconductor substrate and enables the processor to control an operating frequency and a substrate bias voltage and which is characterized by comprising a means/step of calculating necessary operation volume for calculating the volume of operation necessary for encoding/decoding the present frame, ie one arbitrary frame ready to be encoded or decoded, and a means/step of deciding substrate bias voltage and operating frequency for deciding a substrate bias voltage and an operating frequency capable of encoding/decoding the volume of necessary operation within a time allocated in advance to the process for encoding/decoding the present frame and permitting the processor to rely on the means/step of encoding/decoding motion picture to perform the process of encoding/decoding the present frame while operating steadily in the unit of frame with the substrate bias voltage and the operating frequency decided by the means/step of deciding substrate bias voltage and operating frequency.

In the regulations of the encoding/decoding procedure (such as MPEG), the processing time is allocated in advance to the present frame. In accordance with the present invention, the means/step of calculating necessary operation volume serves to calculate the volume of operation necessary for encoding/decoding the present frame, the means/step of deciding substrate bias voltage and operating frequency serves to decide a substrate bias voltage and an operating frequency capable of encoding/decoding the volume of necessary operation mentioned above within the time allocated in advance to the process of encoding/decoding the present frame, and the processor serves to use the means/step of encoding/decoding motion picture for performing the process of encoding/decoding the present frame while operating steadily with the operating frequency and the substrate bias voltage calculated as described above. Since the processor is consequently actuated with fixed substrate bias voltage and operating frequency on each of the frames and enabled to perform the process of encoding/decoding, it is made possible to repress the subthreshold leakage current Ist and promote the decrease of power consumption as compared with the conventional technique which suffers the substrate bias voltage and the operating frequency to vary many times during the process of encoding/decoding the present frame because the operating frequency and the power-supply voltage are decided for each of a prescribed the number of blocks formed by dividing a frame. The substrate bias and the operating frequency of the processor are controlled by the means/step of controlling substrate bias and the means/step of controlling operating frequency, respectively.

If the subthreshold leakage current is repressed excessively, the excess will possibly result in rather inhibiting the decrease of power consumption. For the purpose of promoting the decrease of power consumption more effectively, therefore, it is preferable to control the power-supply voltage in addition to the substrate bias voltage. Now, the relation between the operating frequency and the power-supply voltage-substrate bias voltage will be described in detail below. It is assumed that the current which is consumed in a peripheral device comprising the processor 1 and/or a local decoding memory is represented by the following formula.
I=Icd+Ist

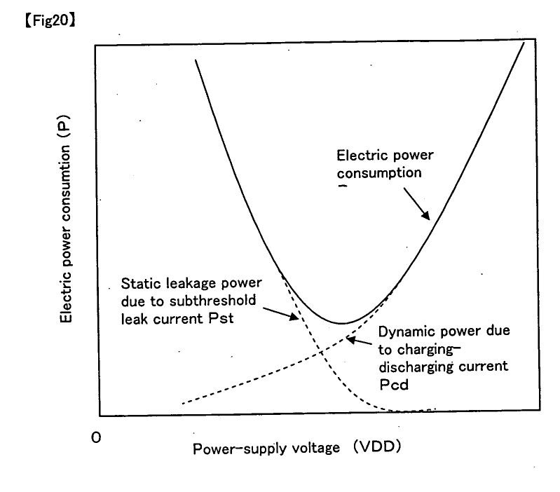

In this formula, Icd denotes a charging/discharging current represented by the following formula.
Icd=a×C×f×VDD
wherein a denotes a coefficient, C the number of transistors of the processor, f an operating frequency, and VDD a power-supply voltage. Meanwhile, Ist denotes a subthreshold leakage current represented by the following formula.
Ist=I₀×10ˆ((Vgs−Vt)/S)
wherein I denotes a constant, Vgs a voltage between a gate and a source, Vt a threshold voltage (Ttn or −Vtp), and S a subthreshold swing. The threshold voltage is represented by the following formula using a substrate bias voltage.
Vt=Vt0+γ√(δ−VBB)
wherein Vt0, γ, and δ each denote a constant and VBB denotes a substrate bias voltage (Vbn or −Vbp). Meanwhile, the operating frequency is represented by the following formula using a power-supply voltage and a threshold voltage.
f=K×(VDD−Vt)ˆα/VDD
wherein K and a each denote a coefficient. The power consumption P in the circuit is represented by the following formula.
P=Pcd+Pst
wherein Pcd=VDD×Icd, ie a dynamic electric power due to a charging/discharging current and Pst=VDD×Ist, ie a static leakage current due to a subthreshold leakage current. FIG. 20 is a diagram showing the relation between the electric power consumption P and the power-supply voltage VDD when the operating frequency f of the processor is fixed. When the power-supply voltage VDD of the processor 1 is lowered, for example, the charging/discharging current is decreased. For the purpose of maintaining the operating frequency f, however, the threshold voltage Vt is required to be decreased by increasing the substrate bias voltage Vbn and/or −Vbp and, consequently, inducing the subthreshold leakage current Ist to increase in the form of an exponential function. The electric power consumption P, therefore, has the minimum value of its own and entails the occurrence of the power-supply voltage VDD and the substrate bias voltage Vbn and/or −Vbp in such a combination as minimizes the power consumption. By controlling the power-supply voltage VDD and the substrate bias voltage Vbn and/or −Vbp and actuating the processor 1 with such power-supply voltage VDD and substrate bias voltage Vbn and/or −Vbp as minimize the electric power consumption P relative to a specific operating frequency f, it is made possible to promote the decrease of power consumption more effectively.

The inventors, concerning the processor which is a semiconductor device implemented with MOS transistors laminated thereon, have been further ascertained that the decrease of power consumption of the processor can be realized by controlling the substrate bias voltage and the power-supply voltage thereby repressing GIDL (Gate-Induced Drain Leakage), DIBL (Drain-Induced Barrier Lowering), the gate leakage, and other current besides the charging/discharging current and the subthreshold leakage current. The GIDL is a current that flows from the drain toward the substrate owing to the phenomenon of tunneling. Also, the DIBL is a current that flows because the barrier of the source is lowered and the carrier is injected from the source into the channel surface when the drain voltage of the MOS transistor is high. The gate leakage is a current that flows from the gate toward the channel owing to the phenomenon of tunneling occurring in the gate oxide film of the MOS transistor. The DIBL is a function solely of power-supply voltage and the GIDL, gate leakage, and other electric currents are functions of power-supply voltage and substrate bias voltage. When these leakage currents are taken into consideration, the electric power consumption P in the processor is represented by the following formula;
P=Pcd+Pst+PGIDL+PDIBL+Pgl+Pother
wherein Pcd denotes a charging/discharging electric power, Pst an electric power consumed by subthreshold leakage, PGIDL an electric power consumed by GIDL, PDIBL an electric power consumed by DIBL, Pgl an electric power consumed by gate leakage, and Pother other electric power consumptions. The electric power consumption P constitutes a function of power-supply voltage and substrate bias voltage. Even in this case, the decrease of power consumption can be promoted more effectively by causing the processor to be actuated with such power-supply voltage and substrate bias voltage as minimize the total power consumption relative to a prescribed operating frequency.

The present inventors have been enabled by controlling not only the substrate bias voltage but also the power-supply voltage in accordance with the foregoing results to perfect this invention which is directed toward moderately repressing the subthreshold leakage current, charging/discharging current, and other leakage currents.

Specifically, the method/system of this invention for encoding/decoding a motion picture concerns a motion picture encoding/decoding system/method, which incorporates a means/step of encoding/decoding motion picture for sequentially encoding/decoding a motion picture formed of a plurality of successive frames in the unit of frame by the use of a processor implemented with MOS transistors laminated on a semiconductor substrate and enables the processor to control an operating frequency, a substrate bias voltage, and a power-supply voltage and which is characterized by comprising a means/step of calculating necessary operation volume for calculating the volume of operation necessary for encoding/decoding the present frame, ie one arbitrary frame ready to be encoded or decoded, and a power-supply voltage-means/step of deciding substrate bias voltage and operating frequency for deciding a power-supply voltage, a substrate bias voltage, and an operating frequency capable of encoding/decoding the volume of necessary operation within a time allocated in advance to the process for encoding/decoding the present frame and permitting the processor to rely on the means/step of encoding/decoding motion picture to perform the process of encoding/decoding the present frame while operating steadily in the unit of frame with the substrate bias voltage, the power-supply voltage, and the operating frequency decided by the means/step of deciding power-supply voltage, substrate bias voltage and operating frequency.

Since the electric power consumption P is affected greatly by not merely the subthreshold leakage current Ist but also the charging/discharging current Icd and other leakage currents as described above, it is made possible to repress moderately the subthreshold leakage current Ist and the charging/discharging current Icd and other leakage currents and realize the decrease of power consumption more effectively by controlling the power-supply voltage in conjunction with the substrate bias voltage. According to this invention, the processor is expected to perform the process of encoding/decoding while operating with fixed power-supply voltage, substrate bias voltage, and operating frequency for each of the frames. It is enabled to promote the decrease of power consumption as compared with the conventional technique which suffers the power-supply voltage and the operating frequency to vary many times during course of the encoding/decoding process because the operating frequency, the power-supply voltage, and the substrate bias voltage are decided for each of the prescribed the number of blocks formed by dividing a frame. Since the control is affected on not only the substrate bias voltage but also the power-supply voltage, the subthreshold leakage current Ist, the charging/discharging current, and other leakage currents are moderately repressed and the decrease of power consumption is realized more effectively. Here, the power-supply voltage and the substrate bias voltage which fit a fixed operating frequency are preferred to be in such a combination as minimizes the electric power consumption P.

The motion picture encoding/decoding system/method of the present invention is characterized by the processor allowing the operating frequency thereof to vary in r steps (r denoting an integer of not less than 2) and the means/step of calculating operating frequency and substrate bias voltage which calculates the operating frequency Fe necessary for processing the necessary operation volume Kp with the time Te by the formula Fe=Kp/Te using the necessary operation volume Kp of the present frame calculated by the means/step of calculating necessary operation volume and the time Te allocated to the processing of the present frames selecting from the operating frequencies available for the operation of the processor an operating frequency exceeding the necessary operating frequency Fe mentioned above and approximating most closely to the operating frequency Fe, and deciding a substrate bias voltage suitable for the selected operating frequency. The motion picture encoding/decoding system/method of the present invention is characterized by the processor allowing the operating frequency thereof to vary in r steps (r denoting an integer of not less than 2) and the means/step of deciding power-supply voltage, substrate bias voltage and operating frequency calculating the operating frequency Fe necessary for processing the necessary operation volume Kp with the time Te by the formula Fe=Kp/Te using the necessary operation volume Kp of the present frame calculated by the means/step of calculating necessary operation volume and the time Te allocated to the processing of the present frame, selecting from the operating frequencies available for the operation of the processor an operating frequency exceeding the necessary operating frequency Fe mentioned above and approximating most closely to the operating frequency Fe, and deciding a substrate bias voltage and a power-supply voltage suitable for the selected operating frequency.

According to these inventions, after the operating frequency Fe necessary for processing the necessary operation volume Kp within the time Te has been calculated by the formula Fe=Kp/Te, the calculation for selecting from operating frequencies available for the operation of the processor an operating frequency exceeding the necessary operating frequency Fe mentioned above and approximating most closely to this operating frequency Fe is carried out, the decision of a substrate bias voltage suitable for the selected operating frequency F or the decision of a power-supply voltage and a substrate bias voltage suitable for the selected operating frequency is made as well, and the operation of the processor is steadily continued and meanwhile the process for encoding/decoding the present frame is carried out by the means/step of encoding/decoding motion picture. Alternatively mentioned, the decrease of power consumption is efficiently attained even when the processor in use has the feasible operating frequency thereof vary stepwise because the process for encoding/decoding the present frame is performed by the means/step of encoding/decoding implemented on the processor while the processor is fixedly operated with the smallest operating frequency capable of processing the necessary operation volume Kp within the time Te allocated to the present frame and the substrate bias voltage suitable for that operating frequency among other operating frequencies and substrate bias voltages available for the operation of the processor or because the process for encoding/decoding the present frame is performed by the means/step of encoding/decoding implemented on the processor while the processor is fixedly operated with the smallest operating frequency capable of processing the necessary operation volume Kp within the time Te allocated to the present frame and the substrate bias voltage and the substrate bias voltage suitable for that operating frequency among other operating frequencies, power-supply voltages, and substrate bias voltages available for the operation of the processor.

The motion picture encoding/decoding system/method of the present invention is characterized by being furnished with a means/step of avoiding failure situation capable of avoiding the failure situation which occurs when the necessary operation volume calculated by the means/step of calculating necessary operation volume mentioned above is smaller than the operation volume that is actually necessary.

When the necessary operation volume calculated by the means/step of calculating necessary operation volume has a smaller value than the actually necessary operation volume, the failure situation imparting the image of very poor quality ensues because the process for encoding/decoding the present frame is not completed within the time fixed in advance. This invention avoids the occurrence of such failure situation because it is furnished with at least one means/step of avoiding failure situation.

The motion picture encoding/decoding system/method of the present invention is characterized by being at least furnished, as the means/step of avoiding failure situation mentioned above, with a first means/step of avoiding failure situation capable of adding a prescribed amount to the necessary operation volume calculated by the aforementioned means/step of calculating necessary operation volume.

According to this invention, since the means/step of avoiding failure situation adds the prescribed value to the necessary operation volume, the possibility that the necessary operation volume calculated by the means/step of calculating necessary operation volume will satisfy the actual operation volume can be heightened and the failure situation which occurs because the necessary operation volume is smaller than the actual operation volume can be avoided.

The motion picture encoding/decoding system/method of the present invention is characterized by the fact that the aforementioned first means/step of avoiding failure situation multiplies the necessary operation volume calculated by the means/step of calculating necessary operation volume to m folds (m denoting a real the number of not less than 1) or adds a real number n greater than 0 to the necessary operation volume.

According to this invention, since the first means/step of avoiding failure situation multiplies the necessary operation volume to m folds or adds a value of n to the necessary operation volume, the adjustment of the value of m or n results in enabling the necessary operation volume calculated by the means/step of calculating necessary operation volume to exceed the real operation volume and approximate closely to the real operation volume and allowing the failure situation to be avoided.

The motion picture encoding/decoding system/method of the present invention is characterized by being furnished, as the aforementioned means/step of avoiding failure situation, with a second means/step of avoiding failure situation which is capable of judging whether or not the necessary operation volume calculated by the aforementioned means/step of calculating necessary operation volume is smaller than the operation volume actually necessary for the process of encoding/decoding performed by the aforementioned means/step of encoding/decoding motion picture and performing the process of avoiding the failure situation when the necessary operation volume is judged to be smaller.

According to this invention, since the second means/step of avoiding failure situation judges whether or not the necessary operation volume calculated by the aforementioned means/step of calculating necessary operation volume is smaller than the actually necessary operation volume and performs the process of avoiding the failure situation when the necessary operation volume is judged to be smaller, the process for avoiding the failure situation is carried out only when the failure situation occurs certainly and the failure situation can be avoided efficiently.

The motion picture encoding system/method of this invention is characterized by being at least furnished, as the aforementioned second means/step of avoiding failure situation, with a means/step of invalidating block which is capable of performing a process of interrupting at a prescribed timing the encoding operation being performed by the means/step of encoding motion picture, discerning the presence or the absence of a macro block which has escaped the encoding process, and performing a process of invalidating the macro block when the presence of this macro block is detected.

When the macro block which has escaped the process of encoding occurs in the duration of time allocated in advance to the process for encoding the present frame, specifically at a prescribed timing such as the timing that leaves behind the time for the process of invalidating all the macro blocks, for example, the possibility that the failure situation will occur is high. According to this invention, the failure situation can be avoided because the means/step of invalidating block, ie the second means/step of avoiding failure situation, interrupts at a prescribed timing the encoding operation being performed by the means/step of encoding motion picture, judges that the necessary operation volume calculated by the aforementioned means/step of calculating necessary operation volume is smaller than the actually necessary operation volume when the macro block which has escaped the process of encoding is present, and performs the process for invalidating the macro block.

The motion picture encoding/decoding system/method of the present invention is characterized by being at least furnished, as the aforementioned second means/step of avoiding failure situation, with a means/step of judging an operation residue which is capable of interrupting at a prescribed timing the process for encoding/decoding being performed by the means/step of encoding/decoding motion picture, adding to the operating frequency of the processor at the time of the interruption when the residue of the necessary operation volume of the present frame calculated by the means/step of calculating necessary operation volume is smaller than the residue of the operation volume actually necessary for the process for encoding/decoding the present frame by the means/step of encoding/decoding, and actuating the processor with the substrate bias voltage suitable for the operating frequency. The motion picture encoding/decoding system/method of the present invention is characterized by being at least furnished, as the aforementioned second means/step of avoiding failure situation, with a means/step of judging an operation residue which is capable of interrupting the process for encoding/decoding being performed at a prescribed timing by the means/step of encoding/decoding motion picture, adding to the operating frequency of the processor at the time of the interruption when the residue of the necessary operation volume of the present frame calculated by the means/step of calculating necessary operation volume is smaller than the residue of the operation volume actually necessary for the process for encoding/decoding the present frame by the means/step of encoding/decoding, and actuating the processor with the power-supply voltage and the substrate bias voltage suitable for the operating frequency.

According to these inventions, the speed of calculation of the processor is enhanced, the volume of feasible operation is increased, and the possibility of avoiding the failure situation is heightened because the means/step of judging an operation residue, ie the second means/step of avoiding failure situation, interrupts at a prescribed timing the process for encoding/decoding being performed by the means/step of encoding/decoding motion picture, adds to the operating frequency of the processor at the time of the interruption when the residue of the necessary operation volume of the present frame calculated by the means/step of calculating necessary operation volume is smaller than the residue of the operation volume actually necessary for the process for encoding/decoding the present frame by the means/step of encoding/decoding, and actuates the processor with the substrate bias voltage suitable for the operating frequency or actuate the processor with the power-supply voltage and the substrate bias voltage suitable for the operating frequency. When the interruption is repeated to a plurality of rounds, the possibility of avoiding the failure situation is further heightened because the operating frequency and the substrate bias voltage or the operating frequency, the power-supply voltage, and the substrate bias voltage can be increased stepwise in conformity with the conditions of process.

The motion picture encoding/decoding system/method of the present invention is characterized, on the assumption that of a plurality of successive frames, those which are subjected to a process of encoding prior to the present frame will be named previous frames, by the fact that the aforementioned means/step of calculating necessary operation volume in the case of encoding a motion picture performs the calculation of the necessary operation volume by using not less than one important factor selected from the group consisting of amounts of movement between the present frame and the previous frame, amount of activity of the present frame, amount of activity of the previous frame, average value of the quantizing step size of the previous frame, difference between the average value of the quantizing step size of the previous frame and the average value of the quantizing step size of the frame directly before the previous frame, the number of macro-block matching of the previous frame, the number of valid blocks of the previous frame, the number of valid coefficients of the previous frame, amount of operation actually required for encoding the previous frame, the number of bits occurring in the previous frame, encoding bit rate of the present frame, kind of the present frame as to discrimination between intra-frame encoding and inter-frame encoding, and necessary operation volume calculated by the means/step of calculating necessary operation volume. The motion picture encoding/decoding system set forth in claim 13 of the present invention is characterized, on the premise of the invention set forth in any of claims 1 to 10 of the invention and on the assumption that of a plurality of successive frames, those which are subjected to a process of encoding prior to the present frame will be named previous frames, by the fact that the aforementioned means/step of calculating necessary operation volume in the case of encoding a motion picture performs the calculation of the necessary operation volume by using not less than one important factor selected from the group consisting of the number of bits of the encoded data of the present frame, kind of the present frame as to discrimination between intra-frame encoding and inter-frame encoding, average value of the size of movement vector of the present frame or the previous frame, dispersion of the size of movement vector of the present frame or the previous frame, the number of valid blocks of the present frame or the previous frame, the number of valid coefficients of the present frame or the previous frame, bit rate of the present frame or the previous frame, amount of signs of the present frame or the previous frame, average value of the quantizing step size of the present frame or the previous frame, difference in the average value of the quantizing step size (difference in the quantizing step size between the present frame and the frame directly before the present frame or difference between the quantizing step size of the frame directly before and the quantizing step size of the frame before the present frame across an intervening frame), amount of operation actually required for decoding the previous frame, and necessary operation volume of the previous frame calculated by the means/step of calculating necessary operation amount.

The plurality of important factors mentioned above are invariably such elements as affect the necessary operation volume in the process for encoding/decoding. According to this invention, the necessary operation volume calculated by the means/step of calculating necessary operation volume approximates closely to the volume of operation actually spent for the process of encoding/decoding because at least one of the important factors mentioned above is used essentially by the means/step of calculating necessary operation volume in calculating the necessary operation volume. As a result, the possibility that the decrease of power consumption will be impeded because the calculated necessary operation volume is unduly larger than the actual volume of operation is not very great and the failure situation manifested in the failure of the process of encoding/decoding to terminate within the allocated time because the necessary operation volume is smaller than the actual volume of operation does not easily occur even without recourse to the means/step of avoiding failure situation mentioned above.

### EFFECT OF THE INVENTION

According to the motion picture encoding/decoding system and the motion picture encoding/decoding method of this invention, the decrease of power consumption can be realized by performing a calculation for estimating the necessary operation volume required for encoding/decoding the present frame ready to be encoded or decoded (the frame to be encoded or decoded in the future) and controlling the calculation with a fixed operating frequency within a time allocated to the process of the present frame thereby enabling the substrate bias voltage-operating frequency or the power-supply voltage, substrate bias voltage and operating frequency to be dynamically controlled in the unit of frame as described above.

Further, owing to the provision of the means/step of avoiding failure situation, the failure situation which occurs when the necessary operation volume calculated by the means/step of calculating necessary operation volume is smaller than the actually required volume of operation can be avoided and the motion picture resulting from the process for encoding/decoding can be prevented from being degraded.

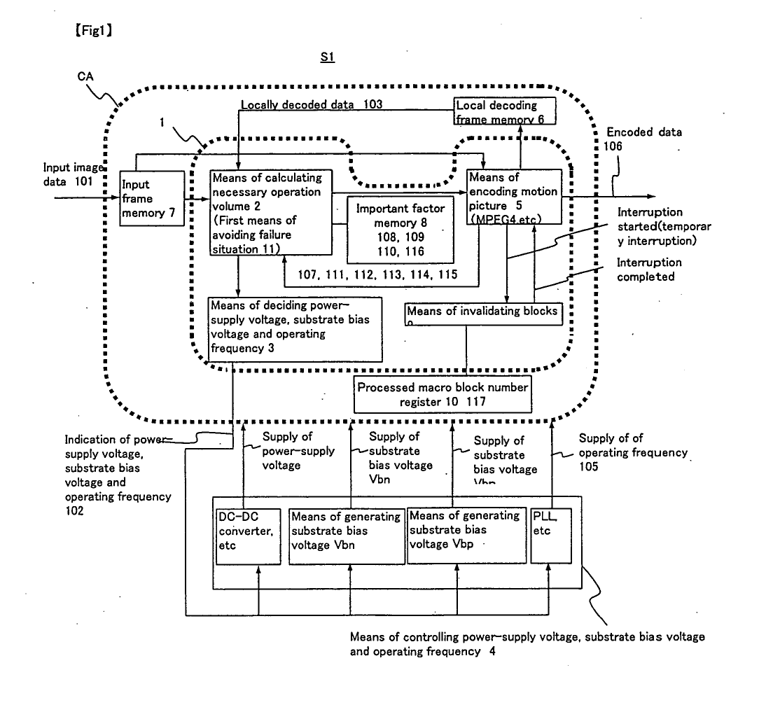

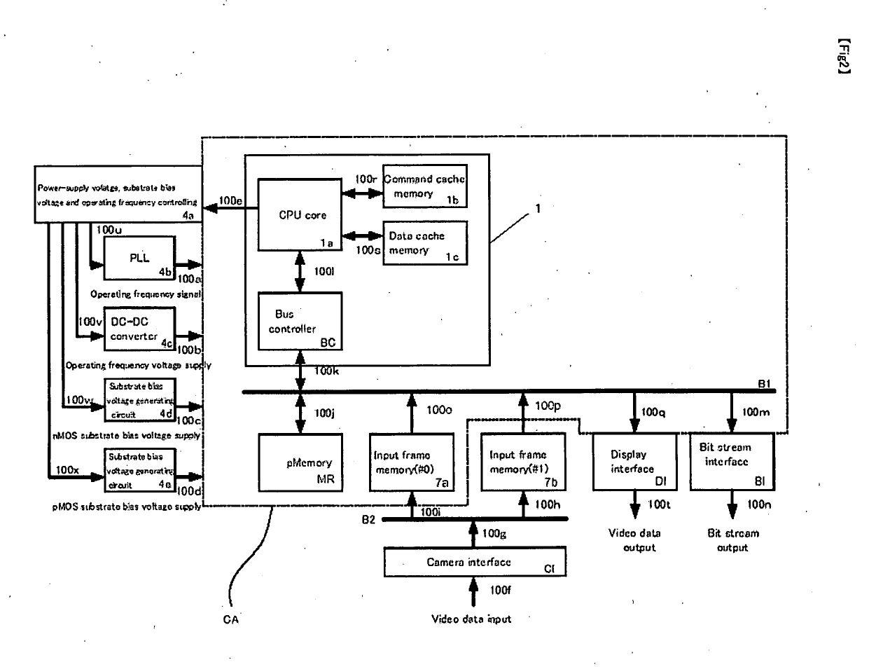

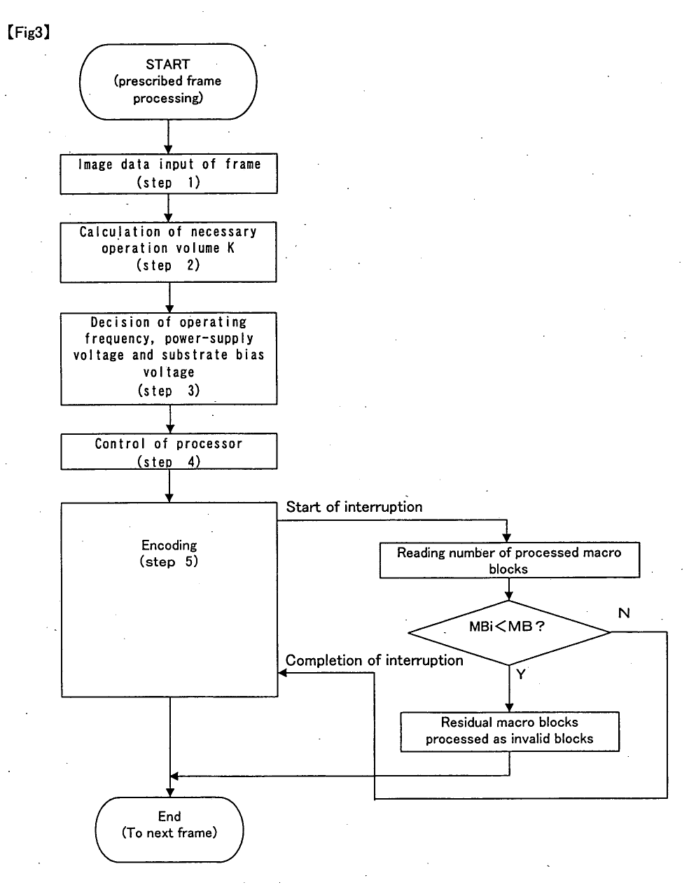

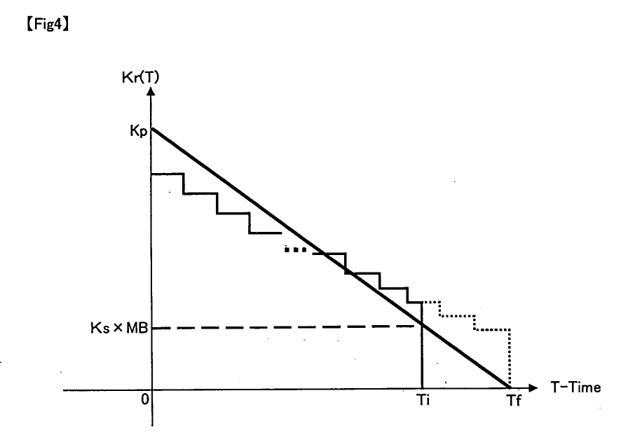

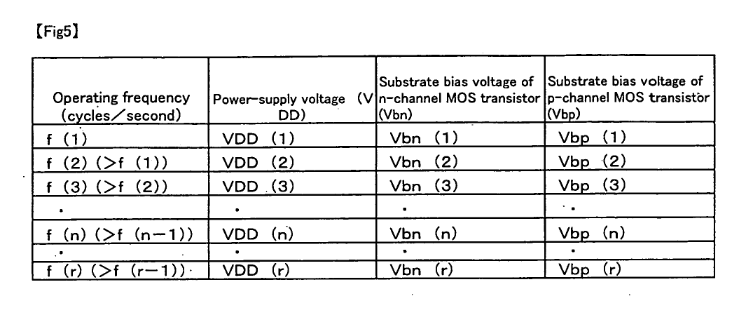

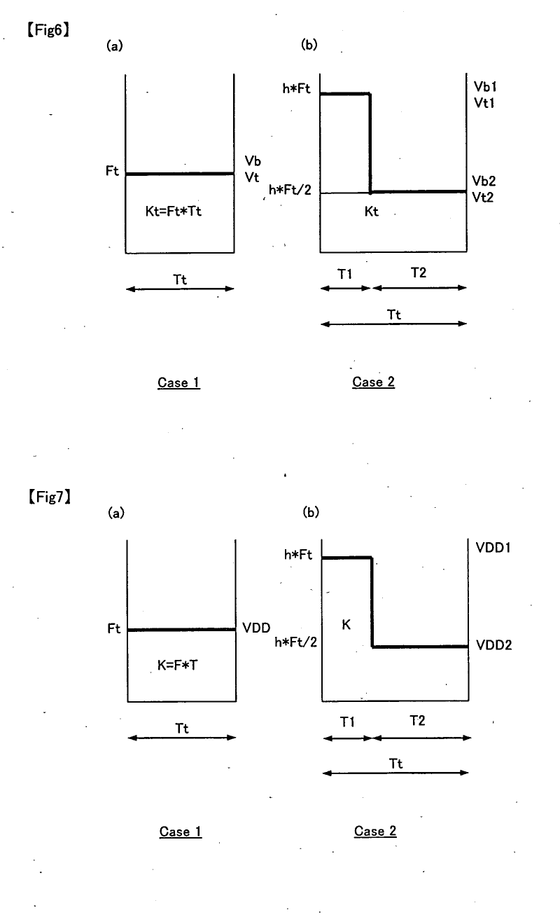

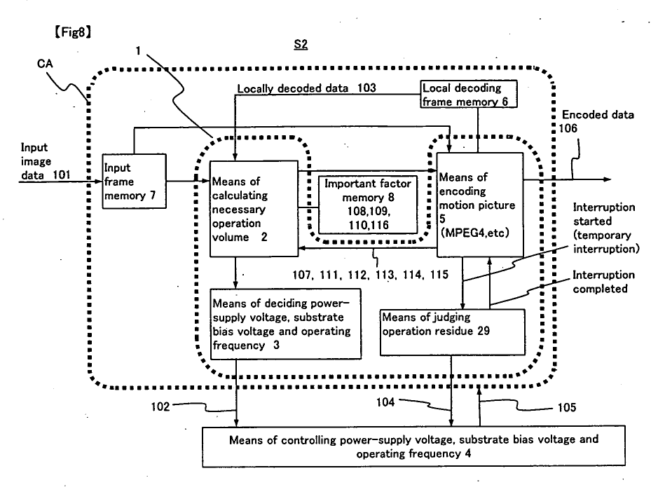

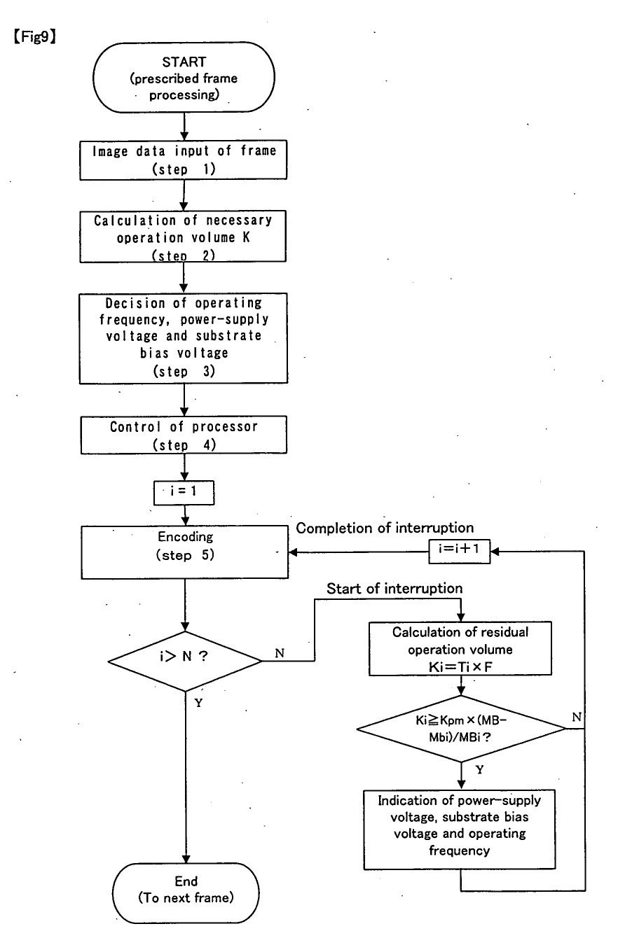

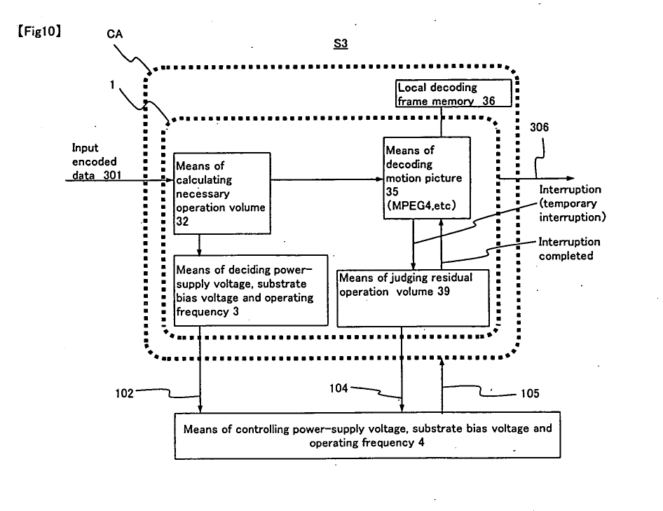

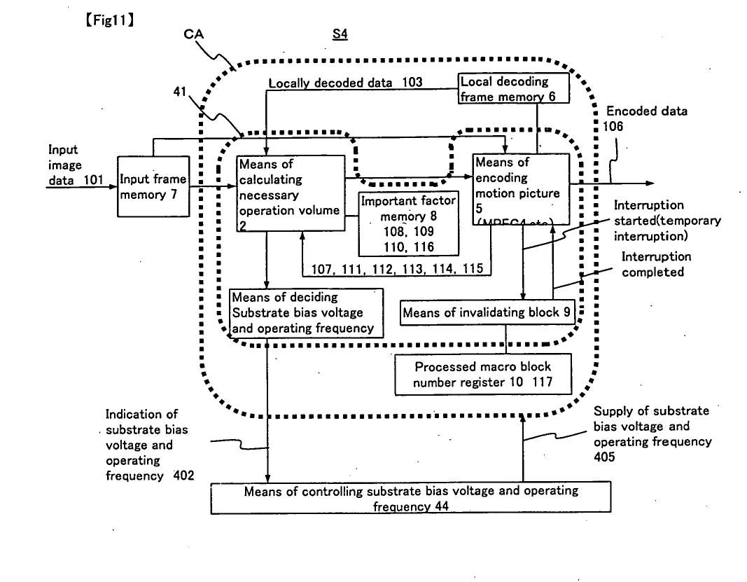

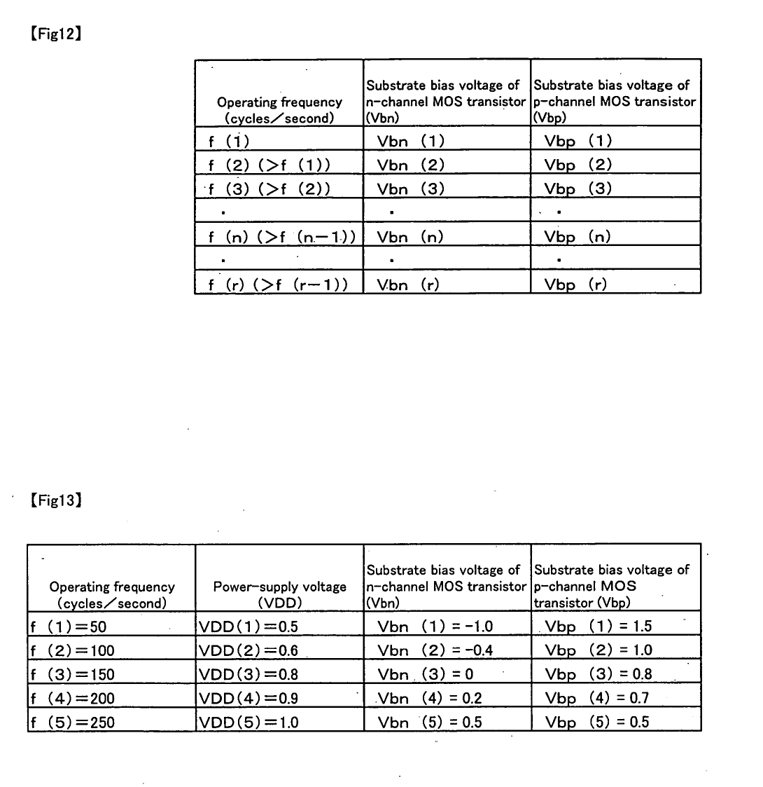

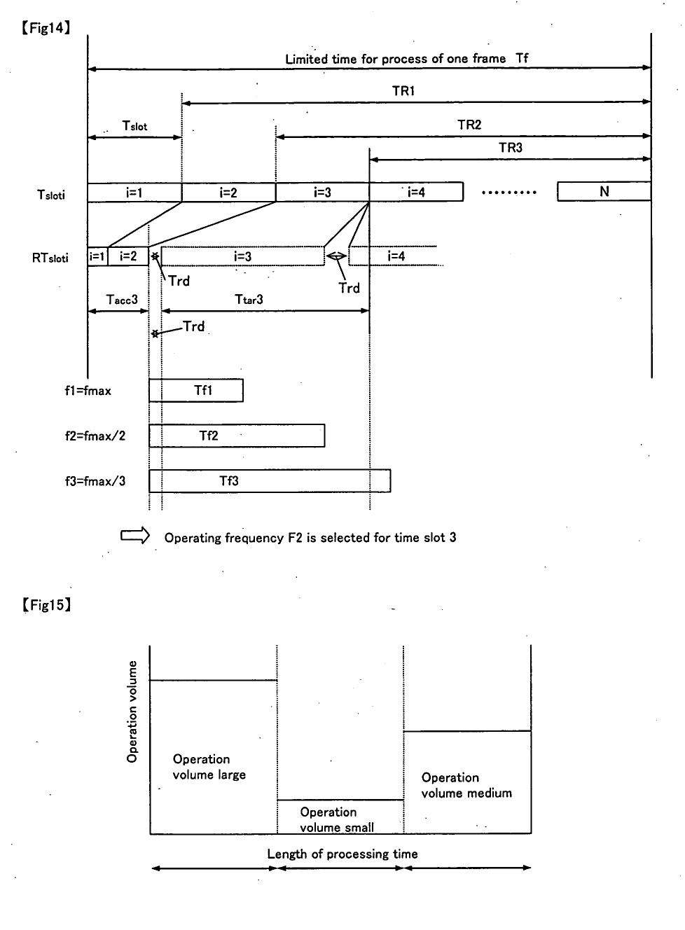

### BRIEF DESCRIPTION OF THE DRAWINGS

[FIG. 1] This is a schematic block diagram illustrating the operation of a motion picture encoding system in the first mode of embodiment of this; invention.

[FIG. 2] This is a diagram depicting an example of mounting the image-varying image encoding system of the previous mode of embodiment.

[FIG. 3] This is a diagram showing a schematic flow chart of the time-varying encoding program for causing the time-varying encoding system of the previous mode of embodiment to function as a computer.

[FIG. 4] This is a diagram showing the relation between the time for the process of encoding and the residue of operation in the motion picture encoding system of the previous mode of embodiment.

[FIG. 5] This is a conceptual diagram illustrating the power-supply voltage, substrate bias voltage and operating frequency of a processor used in the motion picture encoding system of the previous mode of embodiment.

[FIG. 6] This is an explanatory diagram depicting the principle that the subthreshold leakage current can be repressed by fixing the operating frequency.

[FIG. 7] This is an explanatory diagram depicting the principle that the decrease of power consumption can be promoted by fixing the power-supply voltage and the operating frequency.

[FIG. 8] This is a schematic block diagram illustrating the operation of a time-varying encoding system in the second mode of embodiment of this invention.

[FIG. 9] This is a schematic flow chart of the motion picture encoding program for causing the motion picture encoding system of the previous mode of embodiment to function as a computer.

[FIG. 10] This is a schematic block diagram illustrating the operation of a motion picture decoding system in the third mode of embodiment of this invention.

[FIG. 11] This is a schematic block diagram illustrating the operation of a time-varying encoding system in the fourth mode of embodiment of this invention.

[FIG. 12] This is a conceptual diagram illustrating the substrate bias voltage-operating frequency of a processor used in the motion picture encoding system in the previous mode of embodiment.

[FIG. 13] This is a diagram showing an example of the relation between the operating frequency and the power-supply voltage and the substrate bias voltage of the processor in a working example.

[FIG. 14] This is a diagram showing the conventional procedure for decreasing power consumption in a motion picture encoding system.

[FIG. 15] This is a conceptual diagram illustrating the state of variation of the amount of operation for encoding/decoding a motion picture in the unit of frame.

[FIG. 16] This is a cross section illustrating a triple-well structure.

[FIG. 17] This is a diagram showing an example of the relation between the threshold voltage and the substrate bias voltage in an n-channel MOS transistor, a p-channel MOS transistor.

[FIG. 18] This is a diagram showing an example of the relation between the operating frequency and the threshold voltage in a processor.

[FIG. 19] This is a diagram showing an example of the relation between the subthreshold leakage current and the gate voltage and the threshold voltage.

[FIG. 20] This is a diagram showing the relation between the current and the power-supply voltage existing when the operating frequency of the processor is fixed.

### EXPLANATION OF SIGNS

S1, S2, S4 Motion picture encoding systems
S3 Motion picture decoding system
1 Processor
2 Means of calculating necessary operation volume
3 Means of deciding power-supply voltage, substrate bias voltage and operating frequency
4 Means of controlling power-supply voltage, substrate bias voltage and operating frequency
5 Means of encoding motion picture
6 Local decoding frame memory
7 Input frame memory
8 Elemental memory
9 Second means of avoiding failure situation (means of invalidating block)
10 Processed macro block number register
11 First means of avoiding failure situation
101 Input image data
102 Command of power-supply voltage, substrate bias voltage and operating frequency
103 Locally decoded data
104 Command of power-supply voltage, substrate bias voltage and operating frequency
105 Power-supply voltage, substrate bias voltage and operating frequency supply
106 Encoded data
107 Average value of quantizing step size of previous frame
108 Kind of each frame as to discrimination between intra-frame encoding and inter-frame encoding
109 Encoding bit rate of motion picture
110 Amount of activity of previous frame (frame in the past)
111 The number of macro-block matching of previous frame
112 The number of valid blocks of previous frame
113 The number of valid coefficients of previous frame
114 Difference between the average value of quantizing step size of previous frame and the average value of quantizing step size of frame directly before the previous frame
115 Amount of operation actually required for encoding previous frame
116 Necessary operation volume of previous frame calculated by means of calculating necessary operation volume
117 The number of processed macro blocks
29 Second means of avoiding failure situation (means of judging residual operation)
35 Means of decoding motion picture
36 Local decoding frame memory
39 Second means of avoiding failure situation (means of judging residual operation)
301 Input encoded data
306 Decoded data
42 Means of deciding substrate bias and operating frequency
44 Means of controlling substrate bias-operating frequency
402 Command of substrate bias voltage and operating frequency
405 Supply of substrate bias voltage-operating frequency
p-type semiconductor substrate
n-type well
p-type well

### BEST MODE OF EMBODYING THE INVENTION

Now, the motion picture encoding/decoding system and the motion picture encoding/decoding method of this invention will be described below. The motion picture encoding/decoding system of this invention causes a processor 1 specifically described herein below to perform a process for encoding a motion picture and decoding a motion picture and functions as a motion picture encoding system in the case of encoding a motion picture and as a motion picture decoding system in the case of decoding a motion picture. The motion picture encoding/decoding system of this invention may perform the process for encoding/decoding in the unit of frame or in the unit of time, or may perform solely the process for decoding or solely the process for encoding. Hereinafter, for the sake of convenience, the process for encoding a motion picture and the process for decoding a motion picture will be separately described in detail with reference respectively to the time-varying encoding system in the case of encoding and the time-varying decoding system in the case of decoding. The processes performed by the individual means to be specifically described herein below correspond to the individual steps of the method for encoding/decoding a motion picture according to this invention.

### First Mode of Embodiment

A motion picture encoding system S1 in the first mode of embodiment of this invention is aimed at decreasing power consumption by controlling an operating frequency, a substrate bias voltage, and a power-supply voltage thereby repressing moderately a subthreshold leakage current, a charging/discharging current and other leakage currents. This system S1 is realized in a portable telephone having a microcomputer incorporated therein or in a computer, ie an information terminal device such as for a personal computer. Particularly it functions as part of a multi-media signal processing part in the computer and sequentially encodes a motion picture formed of a prescribed number of successive frames in the unit of frame.

FIG. 1 is a schematic block diagram illustrating the operation of the motion picture encoding system S1 in the present mode of embodiment. The motion picture encoding system S1 is a computer (particularly a multi-media signal processing part) which is provided at least with a processor 1 allowing a power-supply voltage VDD, substrate bias voltages Vbn and Vbp, and an operating frequency f to vary in r steps (r denoting an integer of not less than 2, allowing itself to operate in r steps of the power-supply voltage VDD, substrate bias voltages Vbn and Vbp, and operating frequency f), a means of controlling power-supply voltage, substrate bias voltage and operating frequency 4 for controlling the power-supply voltage and the substrate bias voltage and the operating frequency of the processor 1, a local decoding frame memory 6 which is a memory region for storing a prescribed data, an input frame memory 7, an element memory 8, and a processed macro-block number register 10. It is provided that Vbn denotes a substrate bias voltage of an n-channel MOS transistor and Vbp a substrate bias voltage of a p-channel MOS transistor.

The processor 1 is a semiconductor device on a triple-well structure as illustrated in FIG. 16 and is capable of controlling the substrate bias voltage for each of the MOS transistors. The local decoding memory 6 and the input frame memory 7 are a semiconductor memory device having a power-supply voltage, substrate bias voltage and operating frequency thereof controlled similarly to the processor 1 by the means of controlling power-supply voltage, substrate bias voltage and operating frequency 4. In the present mode of embodiment, it is adapted to control operating frequency, power-supply voltage and substrate bias voltage in the elements contained in a control area CA indicated with a dotted line (the processor 1, the local decoding frame memory 6, the element memory 8, the processed macro-block number resister 10, and input frames 7a, 7b, etc.).

The means of controlling power-supply voltage, substrate bias voltage and operating frequency 4 is composed of a means of controlling power-supply voltage provided as with a DC-DC converter, a means of generating substrate bias voltage Vbn intended to control the substrate bias voltage of the n-channel MOS transistor, a means of generating substrate bias voltage Vbp intended to control the substrate bias voltage of the p-channel MOS transistor, and a means of controlling operating frequency provided as with a PLL. It is provided, however, that the component elements of the means of controlling power-supply voltage, substrate bias voltage and operating frequency 4 may exist outside the system S1 performing the process of encoding a motion picture and control the power-supply voltage or the substrate bias voltage or the operating frequency from outside the motion picture encoding system S1. The processor 1, the memories 6 and 7, and the means of controlling power-supply voltage, substrate bias voltage and operating frequency 4 are mutually connected via a wiring.

The processor 1 is provided, as means to operate on the processor 1, with a means of calculating necessary operation volume 2, a means of calculating power-supply voltage, substrate bias voltage and operating frequency 3, a means of encoding motion picture 5, and two means of avoiding the failure situation 9 and 11. The two means of avoiding the failure situation 9 and 11 are intended to avoid the failure situation which occurs when the necessary operation volume calculated by the means of calculating necessary operation volume 2 is smaller than the operation volume actually required for the process of encoding performed by the means of encoding 5 and are specifically the first means of avoiding the failure situation 11 functioning as part of the means of calculating necessary operation volume 2 and the means of invalidating blocks 9 serving as the second means of avoiding the failure situation. Incidentally, the sign 101 denotes an input image data sign 102 a command of power-supply voltage, substrate bias voltage and operating frequency, the sign 103 a local decoded data for the previous frame, the sign 105 a supply of power-supply voltage, substrate bias voltage and operating frequency, the sign 106 a frame encoded data, sign 107 an information of the average value of the quantizing step size of the previous-frame, the sign 108 kind of each of the frame as to discrimination between an intra-coding frame and an inter-coding frame, the sign 109 an information of the encoding bit rate of a motion picture, the sign 110 an amount of activity of the previous frame, the sign 11 the number of macro-block matching of the previous frame, the sign 112 the number of valid blocks of the previous frame, the sign 112 the number of valid coefficients of the previous frame, the sign 114 a difference between the average value of the quantizing step size of the previous frame and the average value of the quantizing step size of the frame directly before the previous frame, the sign 115 an amount of operation actually required for encoding the previous frame, the sign 116 a necessary operation volume of the previous frame calculated by the means of calculating necessary operation volume 2, and the sign 117 the number of processed macro blocks, ie the number of macro blocks having undergone the process for encoding. The element memory 8 constitutes a memory region for storing part of the plurality of important factors used in the means of calculating necessary operation volume 2 to be specifically described herein below (the kind 108 as to the discrimination between an intra-frame coding and an inter-frame coding, the coding bit rte 109, the amount 110 of activity of the frame, and the necessary operation volume 116 calculated by the means of calculating necessary operation volume 2). The processed macro-block number register 10 is a register for temporarily accumulating the information the number 117 of macro blocks having undergone the process for encoding. While MPEG-4 is adopted as a method of encoding herein for the means of encoding motion picture 5, such other methods of encoding as H. 26×, MPEG-1, and MPEG-2 are also available.

FIG. 2 depicts an example of the mounting of the motion picture encoding system S1. The system S1 is realized by a hardware provided with the processor 1 as a main element, various memories MR 7a and 7b as peripheral units, various interfaces CI, DI, and BI, and a means of controlling power-supply voltage, substrate bias voltage and operating frequency 4 and various component elements mentioned above are enabled to communicate mutually via buses B1 and B2.

The processor 1 is provided with a processor core 1a, an instruction cache memory 1b, and a data cache memory 1c. The means of calculating necessary operation volume 2, the means of deciding power-supply voltage, substrate bias voltage and operating frequency 3, the means of encoding motion picture 5, and the means of avoiding failure situation 9 and 11 are realized by the fact that the programs stored in the memories MR are executed on the processor core 1a as required. The instruction cache memory 1b and the data cache memory 1c are provided for the purpose of promoting the acceleration of the process of program executed on the processor core 1a.

The local decoding frame memory 6, the element memory 8, and the processed macro-block number register 10 are condensed in a memory MR shown in FIG. 2. At the same time, an average value 107 of the quantizing step size of the previous frame, a kind 108 of each frame as to the discrimination between an intra-frame encoding and an inter-frame encoding, a motion picture encoding bit rate 109, an amount 110 of activity of the previous frame (the frame in the past), a number 111 of macro-block matching of the previous frame, the number 112 of valid blocks of the previous frame, the number 113 of valid coefficients of the previous frame, a difference 114 of the average value of the quantizing step size of the previous frame and the average value of the quantizing step size of the frame directly before the frame, an operation volume 115 actually required for encoding the previous frame, a necessary operation volume 116 of the previous frame calculated by the means of calculating necessary operation volume, and a number 117 of the processed macro blocks are contained as data in the memory Mr. The locally decoded data 103 is transmitted and received as signals 100j, 100k, and 1001 between the memory M and the processor core 1a via a bus controller BC.

The two input frame memories 7a and 7b correspond to the frame memory 7 shown in FIG. 1. The video input (an input image data 101) inserted from a camera interface CI is caused to enter an input frame memory 7a (or an input frame memory 7b) via a bus B2. The input frame memory (#0) 7a and the input frame memory (#1) 7b exchange their services each time the process of one frame is completed. Specifically, when the process of the first frame causes the input image data to be written in the input frame memory (#1) 7b with a signal 100h and the input image data to be read out of the input frame memory (#0) 7a with a signal 100o for the purpose of the process of encoding by the means of encoding motion picture, the input image data is written in the input frame memory (#0) 7a with a signal 100i and the input image data is read out of the input frame memory (#1) 7b with a signal 100p for the purpose of the process of encoding by the means of encoding motion picture in the process of the (i+1)′th frame. As a result, the signal p does not occur when the input image data has been written in the input frame memory (#1) 7b with the signal 100h and, conversely, the signal 100h does not occur when the image has been read out with the signal p. By the same token, the signal 100o does not occur when the input image data has been written in the input frame memory (#0) 7a with the signal 100i and the signal 100i does not occur when the input image data has been read out of the input frame memory (#0) 7a with the signal 100o. At this time, the input frame memory (#0) 7a in the process of the first frame and the input frame memory (#1) 7b in the process of the (i+1)th frame severally constitute the objects of control of the operating frequency, the power-supply voltage and substrate bias voltage. By preparing input frame memories enough for two frames and enabling their operating frequencies to be set independently of each other as described above, the operation of writing in the input image data from the camera interface CI which has a constant frequency and the operation of reading out the input image data destined to have the operating frequency vary based on the calculated value of the necessary operation volume are enabled to be executed without inducing mutual interruption.

A circuit of controlling power-supply voltage, substrate bias voltage and operating frequency 4a is capable of intercommunicating with a PLL 4b, a DC-DC converter 4c, a MOS-grade substrate bias voltage generating circuit 4d, and a p MOS-grade substrate bias voltage generating circuit 4e. They are functioning collectively as the means of controlling power-supply voltage, substrate bias voltage and operating frequency 4. The circuit of controlling power-supply voltage, substrate bias voltage and operating frequency 4a receives a command of power-supply voltage, substrate bias voltage and operating frequency 102 with a signal 100e from the processor core 1a, transmits a signal 100u to the PLL 4b based on the command 102, transmits a signal 100v to the DC-DC converter 4c, and transmits signals 100w and 100x respectively to substrate bias voltage generating circuits 4d and 4e. The PLL 4b transmits an operating frequency signal 100a based on the signal 100u, the DC-DC converter supplies a power-stipply voltage 100b based on the signal 100v, and the substrate bias voltage generating circuits 4d and 4e supply an nMOS substrate bias voltage 100c and a pMOS substrate bias voltage 100d based respectively on the signals 100w and 100x. Consequently, the operating frequency, the power-supply voltage, and the substrate bias voltage are controlled with respect to the component elements included in the control area CA indicated by a dotted line in FIG. 2 (the processor 1, memories MR, input frame memories 7a and 7b, bus controller BC, etc.). The signals 100e, 100j, 100k, 100l, 100m, 100o, 100p, 100q, 100r, and 100s have their frequencies and signal levels vary in conformity with the operating frequency signal 100a emitted by the PLL 4b and the power source voltage supply 100b emitted by the DC-DC converter 4c.

An encoded data 106 which has been encoded by the means of encoding motion picture 5 operating on the processor 1 is transmitted as the signal 100m to a bit stream interface BI via a bus B1 and produced as a signal 100n and also transmitted as to the memory MR functioning as the local decoding frame memory 6. Then, the data such as an image is read out as the signal 100q from the memory via the bus B1 and transmitted to a display interface DI. The signal 100q received in the display interface DI is produced as a video data by a signal 100t. The video data is produced and displayed as a motion picture via a monitor connected to the display interface DI.

While the circuit of controlling power-supply voltage, substrate bias voltage and operating frequency 4 via display interface DI, and the bit stream interface BI are always operated with a fixed power-supply voltage, the signals 100e, 100q, and 100m transmitted and received among them have their signal levels vary in conformity with the changes in the power-supply voltages of the component elements included in the control area CA (the processor 1, the memories MR, the input frame memories 7a, 7b, and so on). For the purpose of absorbing their influences, the circuit of controlling power-supply voltage, substrate bias voltage and operating frequency 4 via display interface DI, and the bit stream interface BI are preferably provided with a level converter serving to correct signal levels of the signals 100e, 100q, and 100m to be received.

Now, the operation of the motion picture encoding system S1 of the present mode of embodiment will be explained with reference to FIG. 1. The motion picture encoding system S1 is realized by causing a computer (particularly the multi-media signal processing part in the computer) to function as a stated means mentioned below with a motion picture encoding program Prg1. Now, on the assumption that of the frames which are sequentially encoded, an arbitrary frame yet to be encoded will be named a present frame (namely the frame to be encoded next relative to the point at which a certain frame has been encoded, ie the frame which has not been subjected to the process of encoding by that point and is expected to undergo the process of encoding in the future) and the frame which has been encoded before the present frame will be named a previous frame, the process for encoding the present frame will be explained below. The process will be invariably carried out at any frames.

FIG. 3 is a diagram showing a schematic flow chart of the motion picture encoding program Prg1. The motion picture encoding program Prg1 causes the computer to function as the means mentioned below at the step 1 through the step 5 which will be specifically described below. (Step 1) The computer enters the image information of the present frame in the input frame memory 7. (Step 2) It is made to function as the means of calculating necessary operation volume 2 serving to calculate the necessary operation volume Kp of the present frame. (Step 3) It is made to function as the means of deciding power-supply voltage, substrate bias voltage and operating frequency 3 serving to decide the operating frequency F, the power-supply voltage VDD, and the substrate bias voltages Vbn and Vbp of the processor in conformity with the necessary operation volume Kp to be calculated. (Step 4) It is made to function as the means of controlling power-supply voltage, substrate bias voltage and operating frequency 4 serving to control the operation of the processor 1 with the operating frequency F, the power-supply voltage VDD, and the substrate bias voltages Vbn and Vbp to be calculated. (Step 5) It is made to function as the means of encoding motion picture 5 for encoding the image information of the present frame. The encoding of the motion picture is accomplished by performing the processes of the step 1 through the step 5 on all the relevant frames in the order in which the successive frames are entered in the input frame memory 7 (namely in the order in which the frames are encoded). It will be explained in detail below.

(Step 1) The input image data is stored for a while in the input frame memory 7, ie a memory area for temporarily storing frames, with the object of enabling the frames to be synchronized with the input image data.

(Step 2: Step of calculating necessary operation volume) The means of calculating necessary operation volume 2 gains access to the input frame memory 7, acquires the input image data 101 of the present frame, and calculates the necessary operation volume Kp necessary for the process of encoding the present frame. Though various methods are conceivable for the calculation of the necessary operation volume Kp, it is preferable to effect the calculation, for example, by using at least one of the important factors capable of affecting the volume of operation for the process of encoding the present frame. As concrete examples of the important factor which is available for the process of encoding a motion picture wherein the substance of the process resides in compensating a motion, the value of strain calculated with the total absolute differential value using the amounts of motion of the present frame and the previous frame, the value calculated with the total absolute differential value of adjoining picture elements as the amounts of activity of the individual frames, the number of macro-block matching, the number of valid blocks, the number of valid coefficients, the encoding bit rate, the number of generated bits, the amount of operation actually required for encoding the previous frame, and the necessary operation volume of the previous frame calculated by the means of calculating necessary operation volume 2 may be cited in view of the fact that the amount of operation is large for an image of violent motion and the amount of operation is small for an image devoid of motion. Here, on the assumption that the individual important factors are such that the value of one important factor alone varies and the values of the other important factors do not vary, the necessary operation volume for the one important factor is increased relatively when this factor has a larger value and the necessary operation volume for the one important factor is decreased relatively when this factor has a smaller value. Then, the necessary operation volume Kp is decreased relatively when the present frame undergoes an intra-frame encoding than when it undergoes an inter-frame encoding and the necessary operation volume Kp is increased relatively when the present frame undergoes an inter-frame encoding than when it undergoes an intra-frame encoding. Alternatively mentioned, since the plurality of important factors affect the necessary operation volume required for the process of encoding the present frame, the necessary operation volume Kp calculated by the means of calculating necessary operation volume 2 assumes a value approximating more closely to the volume of operation actually used in the process of encoding when the means of calculating necessary operating volume 2 performs the relevant calculation so that the necessary operation volume Kp (cycles) may increase or decrease in conformity with these important factors.

In the present mode of embodiment, the value of motion of an input image is estimated (calculated) by performing the relevant calculation using the function G and comparing the input image data 101 of the present frame stored in the input frame memory 7 with a locally decoded data 103 of the decoded previous frame accumulated in the local decoding frame memory 6. The locally decoded data 103 of the previous frame is formed during the process for encoding the previous frame to be encoded before the present frame by decoding with a local decoder the encoded data 106 of the previous frame formed by encoding the previous frame and then stored in the local decoding frame memory 6. As one example of the estimation (calculation) of the value of the motion, the estimation effected by using the total absolute differential value may be cited. Now, the method for determining a total absolute differential value Σ and the necessary operation volume Kp will be explained below. Incidentally, as the image data of the previous frame, though the local decoded data 106 decoded by the local decoder after being encoded may be used, the input image data of the previous frame may be used as it is.

The amounts of motion of the present frame and the previous frame are determined by performing on all the (or sampled) picture elements the calculation of the total absolute differential value Z=Σ|X(i, j)−Y(i,j)| on the assumption that X(i,j) (wherein i denotes the coordinates of the image in the horizontal direction and j the coordinates in the vertical direction) denotes the input image data 101 of the present frame accumulated in the input frame memory 7 and Y(i,j) (wherein i denotes the coordinates of the image in the horizontal direction and j the coordinates in the vertical direction) denotes the locally decoded data 103 of the previous frame accumulated in the local decoding frame memory 6 which will be specifically described herein below. The sign Z denotes the value of this total absolute differential value. Meanwhile, the amount of activity of a frame is determined by calculating the total absolute differential value W of an adjoining picture element in X(i,j), namely Wh=Σ|X(i, j)−X(i−1,j)| in the horizontal direction and Wv=Σ|X(i, j)−X(i,j−1)| in the vertical direction, on all the (or sampled) input images. The sign W denotes the value of the total absolute differential value of the adjoining picture image (namely the amounts of activity of the individual frames).

Let Z stand for the total absolute differential value, Wa for the amount of activity of the present frame, Wb for the amount of activity of the previous frame (the frame in the past), Qprev for the average quantizing step size of the previous frame (the average value of the quantizing step size), M for the number of macro-block matching of the previous frame, B for the number of valid blocks of the previous frame, C for the number of valid coefficients of the previous frame, S for the amount of operation actually required for encoding the previous frame, BR for the encoding bit rate of the present frame, ΔQprev for the difference between the average value of the quantizing step size of the previous frame and the average value of the quantizing step size of the frame directly before the previous frame, D for the number of actually generated bits of the previous frame, and Kp′ for the necessary operation volume of the previous frame calculated by the means of calculating necessary operation volume, and the necessary operation volume Kp will be calculated in accordance with the formula,
Kp=G(Z, Wa, Wb, Qprev, M, B, C, S, Br, ΔQprev, D, Kp′)
Thus, at least one of these important factors is used. It is provided, however, that G denotes the function that is derived from at least one important factor selected from the group consisting of Z, Wa, Wb, Qprev, M, B, C, S, Br, ΔQprev, D, and Kp′. As one example of the function, the formula
Kp=j+αM+βB+γC+δZ+εQprev
may be cited, but not exclusively. As the important factor to be used for calculating the necessary operation volume Kp, the kind I of the present frame as to discrimination between intra-frame encoding and inter-frame encoding is used. The necessary operation volume Kp assumes a small value when the present frame undergoes intra-frame encoding and the necessary operation volume Kp assumes a large value when the frame undergoes inter-frame encoding. That is, when the means of calculating necessary operation volume 2 uses the total absolute differential value Z, it calculates the total absolute differential value, Z=Σ|Xij−Yij|, and subsequently calculates the necessary operation volume, Kp=G(Z, Wa, Wb, Qprev, M, B, C, S, Br, ΔQprev, D, Kp′).

Now, the function G mentioned above will be explained below. When the image produces a large (small) change between the previous frame and the present frame, namely when the total absolute differential value Z is large (small), the number of macro-block matching executed in the present frame becomes large (small) and the volume of operation necessary for the process of detecting the motion of the present frame (which depends on the number of macro-block matching to be executed) becomes large (small). When the amount Wa of activity of the present frame is large (small), this fact means that the present frame contains a high frequency component of the image in a large (small) amount. In this case, the number of valid blocks and the number of valid coefficients generated in the process for encoding the present frame become large (small) and the volume of operation necessary for the IDCT processing of the present frame (which depends on the number of valid blocks to be generated), the volume of operation necessary for the IQ processing (which depends on the number of valid coefficients to be generated), and the volume of operation necessary for the VLD processing (which depends on the number of valid coefficients to be generated) become large (small). As a result, the function G mentioned above is formed so as to set Kp at a large (small) value when such parameters as Z and Wa are large (small).

Since the motion picture has a large correlation between the successive frames, the number of macro-block matching executed by the process of encoding, the number of valid blocks and the number of valid coefficients generated in the process for encoding, the volume of operation required in the process for encoding, and the amount of activity assume immensely approximating values between the temporally successive frames. When M, B, C, S, and Wb are large (small), therefore, the probability that the number of macro-block matching, the number of valid blocks, the number of coefficients, the volume of operation necessitated for the process of encoding, and the amount of activity will become large (small) is high even in the present frame. Further, the formula S≈Kp′ is satisfied when the necessary operation volume estimated by the means of calculating necessary operation volume assumes a value approximating closely to the volume of operation actually required for the process of encoding. As a result, the function G mentioned above is formed so as to set Kp at a large (small) value when such parameters as M, B, C, S, Wb, and Kp′ are large (small).

When the target bit rate is large (small), the value of the quantizing step size is set at a small (large) value, the number of valid blocks and the number of valid coefficients generated in the process of encoding become large (small). When the number of bits generated by the previous frame is large (small) as compared with the target bit rate, the value of the quantizing step size of the present frame is set at a small (large) value and the number of valid blocks and the number of valid coefficients generated in the process of encoding become small (large). The function G mentioned above, therefore, is formed so as to set Kp at a large (small) value when the encoding bit rate BR of the present frame is large (small) and set Kp at a small (large) value when the number D of bits actually generated in the previous frame is large (small) as compared with the BR. The Kp calculated by the function G mentioned above is enabled to assume a value approximating closely to the volume of operation actually necessitated for encoding the present frame by taking into consideration the average quantizing step size Qprev of the previous frame and the difference ΔQprev between the average value of the quantizing step size of the previous frame and the average value of the quantizing step size of the frame directly before the previous frame.

Also, for the purpose of rendering the failure situation difficult to occur, the means of calculating necessary operation volume 2 is preferred to be provided with a first means of avoiding failure situation 11. The first means of avoiding failure situation 11 performs a process such that the first means of avoiding failure situation 11 included in the means of calculating necessary operation volume 2 causes the necessary operation volume Kp to be increased by a prescribed value and consequently allows the calculated necessary operation volume Kp to have a room. To be specific, the necessary operation volume Kp is multiplied to m folds (m denoting a real the number of not less than 1). On the assumption of m=1.1, for example, the calculated necessary operation volume Kp is allowed to contain a room of 10%. The necessary operation volume Kp may add to itself a real number n (n denoting a real number exceeding 0) and may have a room of a certain value without reference to the value of the calculated necessary operation volume. In accordance with the foregoing example, the necessary operation volume Kp to be calculated finally can be determined by the following formulas.
Kp=G(Z)×m
Kp=G(Z)+n
The following formula derived from combining these two formulas is equally conceivable. If the calculated necessary operation volume Kp is nevertheless smaller than the real necessary operation volume Km of the present frame, the failure situation will be avoided by performing a process in the means of invalidating blocks 9, ie a second means of avoiding failure situation which will be specifically described herein below.

Incidentally, the encoding bit rate 109 of a motion picture, the kind 108 of the present frame and the previous frame as to discrimination between an intra-frame encoding and an inter-frame encoding, the amount 110 of activity of the previous frame, and the necessary operation volume 116 of the previous frame calculated by the means of calculating necessary operation volume have been stored in advance in the element memory 8 which is a memory area for storing important factors and are read in the means of calculating necessary operation volume 2 and used therein when the necessary operation volume Kp is calculated. The average value 107 of the quantizing step size of the previous frame, the number of macro-block matching of the previous frame, the number 112 of valid blocks of the previous frame, the number 113 of valid coefficients of the previous frame, the difference 114 between the average value of the quantizing step size of the previous frame and the average value of the quantizing step size of the frame directly before that frame, and the volume of operation 115 actually required for encoding the previous frame are fed back from the means of encoding motion picture 5 to the means of calculating necessary operation volume 2 when the previous frame is subjected to the process of encoding. In the means of calculating necessary operation volume 2, only one of these important factors may be used or a plurality of such important factors may be used in combination.

(Step 3: Step of deciding power-supply voltage, substrate bias voltage and operating frequency) The means of deciding power-supply voltage, substrate bias voltage and operating frequency 3 performs a calculation for estimating the operating frequency Fe (cycles/second) for the sake of the process of the present frame based on the value of the necessary operation volume Kp. Since the smallest unit of the processing time specified by the encoding method is one frame and since the operating frequency Fe (cycles/second) necessitated for the present frame, capable of encoding the aforementioned necessary operation volume Kp within the time Te (seconds), is expressed by the formula, Fe=Kp/Te, wherein Te denotes the time (seconds) allocated to the process for encoding the present frame, the means of deciding power-supply voltage, substrate bias voltage and operating frequency 3 calculates the operating frequency, Fe=Kp/Te. A time of Te allocated to the process for encoding the present frame, however, is the time that remains after subtracting a time Tp for estimating the volume of operation for the present frame and a time Ts for changing the operating frequency, power-supply voltage and substrate bias voltage of the processor from the time Tf for restricting the process of one frame. When the power-supply voltage, substrate bias voltage and operating frequency supported by the peripheral devices including the processor 1 and/or the local decoding memory 6 and so on are changeable in n steps (n denoting an integer of not less than 2) as shown in FIG. 5, the means of deciding power-supply voltage, substrate bias voltage and operating frequency 3 performs a calculation for selecting an operating frequency F(n) satisfying F(n)>Fe and F(n−1)<Fe as well as the operating frequency for performing the process of encoding the present frame, performs a calculation for selecting a power-supply voltage VDD(n) and substrate bias voltages Vbn(n) and Vbp(n) suitable for the operating frequency F(n), and points out the power-supply voltage, substrate bias voltage and operating frequency to the means of controlling power-supply voltage, substrate bias voltage and operating frequency 4 (sign 102) in order that the peripheral devices including the processor 1 and/or the local decoding memory 6 and so on may be operated with the operating frequency F(n), the power-supply voltage VDD(n), and the substrate bias voltages Vbn(n) and Vbp(n). The letter n denotes an integer of not less than 1 and not more than r.

The relation of power-supply voltage, substrate bias voltage and operating frequency of FIG. 5 is such that in the means of deciding power-supply voltage, substrate bias voltage and operating frequency 3, the combinations of power-supply voltage and substrate bias voltage for varying operating frequencies are set in advance so as to keep the current consumed in the processor 1 or in the peripheral devices including the processor 1, the local decoding memory 6 and so on below a prescribed value. It is preferable to determine as by experiment or calculation based on the relation between the subthreshold leakage current Ist and the charging/discharging current Icd and other leakage currents the power-supply voltage VDD and the substrate bias voltages Vbn and Vbp which minimize the power consumption P and combine the power-supply voltage VDD and the substrate bias voltages Vbn and Vbp. Here, when the minimization of current is contemplated, not less than one of the varying current elements is used for the calculation. Incidentally, the substrate bias voltage may be automatically calculated according to the power-supply voltage conforming to the operating frequency by means of the hardware and/or the program built in the means of deciding power-supply voltage, substrate bias voltage and operating frequency 3. Otherwise, the power-supply voltage and the substrate bias voltage may be calculated according to the operating frequency by means of the hardware and/or the program built in the means of deciding power-supply voltage, substrate bias voltage and operating frequency 3.

(Step 4) The means of controlling power-supply voltage, substrate bias voltage and operating frequency 4 supplies the values of the power-supply voltage VDD(n) and the substrate bias voltages Vbn(n) and Vbp(n) and the operating frequency F(n) designated by the means of deciding power-supply voltage, substrate bias voltage and operating frequency 3 to the peripheral devices including the processor 1 and/or the local decoding memory 6 and so on (sign 105) and effects a control directed toward causing the processor to be steadily operated with the power-supply voltage VDD(n) and the substrate bias voltages Vbn(n) and Vbp(n) and the operating frequency F(n). As a result, the peripheral devices including the processor 1 and/or the local decoding memory 6 and so on are enabled to operate with the power-supply voltage VDD(n) and the substrate bias voltages Vbn (n) and Vbp(n) and the operating frequency F(n) which are fixed. To be specific, the means of controlling power-supply voltage built in the means of controlling power-supply voltage, substrate bias voltage and operating frequency 4 effects a control directed toward enabling the processor 1 to operate steadily with the power-supply voltage VDD(n), the means of generating substrate bias voltage Vbn effects a control directed toward enabling the processor 1 to operate steadily with the substrate bias voltage Vbn(n) for the n-channel MOS transistor, the means of generating substrate bias voltage Vbp effects a control directed toward enabling the processor 1 to operate steadily with the substrate bias voltage Vbp(n) for the p-channel MOS transistor, and the means of controlling operating frequency effects a control directed toward enabling the processor 1 to operate steadily with the operating frequency F(n).

The method for applying the substrate bias voltages Vbn and Vbp will be specifically explained below. On the assumption that the potential difference between the substrate bias voltage Vbn(n) and a ground potential Vss for the n-channel MOS transistor is denoted by Vbbn(n) and the potential difference between the substrate bias voltage Vbp(n) and a power-supply voltage Vdd(n) is denoted by Vbbp(n), the relation of the following formulas is satisfied.
Vbn(n)=Vbbn(n)+Vss
Vbp(n)=Vbbp(n)+Vdd(n)
The voltages Vbbn(n) and Vbbp(n) and the power-supply voltage Vdd(n) can be set independently. It is provided, however, that the sign Vbbn(n) denotes a voltage applied to the pn junction between the source and the substrate of the n-channel MOS transistor so that this voltage may not surpass a diffusion potential Vφ and the sign Vbbp(n) denotes a voltage applied to the pn junction between the source and the substrate of the p-channel transistor so that this voltage may not fall short of a diffusion potential −Vφ. The diffusion potential Vφ is usually 0.6 V.

(Step 5: Step of encoding motion picture) The means of encoding motion picture 5 is realized on the processor 1 of a computer by the motion picture encoding program Prg1 and effect a process of encoding by gaining access to the input image data stored in the input frame memory 7 in the unit for encoding a motion picture through the medium of the processor 1. That is, the means of encoding motion picture 5 receives the input image data 101 of the present frame from the input frame memory 7, encodes it, and generates the encoded data 106. At the step 4, the peripheral devices including the processor 1 and/or the local decoding memory 6 and so on are in a state of operating with the fixed power-supply voltage VDD(n), substrate bias voltages Vbn(n) and Vbp(n) and operating frequency F(n) which are supplied from the means of controlling power-supply voltage, substrate bias voltage and operating frequency 4. At the step 5, therefore, the means of controlling power-supply voltage, substrate bias voltage and operating frequency 4 steadily operates the peripheral devices including the processor 1 and/or the local decoding memory 6 and so on with the operating frequency F(n), the power-supply voltage VDD(n), and the substrate bias voltages Vbn(n) and Vbp(n), and the means of encoding motion picture 5 encodes the present frame by the use of the processor 1. It is made possible to promote the decrease of power consumption by causing the peripheral devices including the processor 1 and/or the local decoding memory 6 and so on to operate steadily with a high frequency for an image of high activity (the input image data 101 of the present frame) and with a low frequency for an image of low activity. Furthermore, the means of encoding motion picture 5 has a local decoder that is functioned as decoding the encoded data 106 and the encoded data 106 of the present frame is decoded by the local decoder and accumulated as the locally decoded data 103 in the local decoding frame memory 6. This locally decoded data 103 of the present frame is used when the necessary operation volume Kp for the next frame is calculated. The encoded data 106 of the present frame is either transmitted through a transmission line or accumulated in an accumulating medium.

Incidentally, the control of the substrate bias voltage may be restricted to at least either of the substrate bias voltage Vbp of the p-channel MOS transistor and the substrate bias voltage Vbn of the n-channel MOS transistor, depending on the operating frequency F.

Furthermore, the encoding system S1 is preferred to be provided with a means of avoiding failure situation. For the purpose of solving the problem of the failure situation that the process of the present frame is not completed within the time allocated to the process when the necessary operation volume Kp calculated by the means of calculating necessary operation volume 2 is smaller than the real necessary operation volume of the present frame, the encoding system S1 is provided with the second means of avoiding failure situation which judges whether or not the necessary operation volume calculated by the means of calculating necessary operation volume 2 is smaller than the volume of operation actually required and, when the calculated volume is judged to be smaller, carries out an operation of avoiding the failure situation. In the present mode of embodiment, the means of invalidating blocks 9 is provided as the second means of avoiding failure situation. The means of invalidating blocks 9, while the means of encoding motion picture 5 is executing a routine for encoding the input image data 101 of the present frame at the step 5, interrupts the encoding routine at a prescribed timing, discontinues the interruption for a while in the course of the processing time, judges whether or not the process of encoding the present frame has been terminated, judges that the necessary operation volume calculated by the means of calculating necessary operation volume is smaller than the volume of operation actually required when the presence of a macro block having escaped the process of encoding is detected, and performs a process of invalidating the macro block. Here, if the process of encoding remains yet to be completed when the interruption is made at the point of time at least incapable of inducing the failure situation, the means of invalidating blocks 9 is enabled to preclude the failure situation that the process of encoding cannot be completed within the allocated time as by performing a process of invalidating blocks which resides in changing the remaining process to a process allowing a copious cut, for example.

Now, the means of invalidating blocks 9 will be specifically explained below. FIG. 4 depicts the relation between the time and the residual volume of operation existing during the course of effecting an interruption. It is assumed that within the time T allocated to the process of the present frame operated with the operating frequency F, the number of macro blocks of one frame is denoted by MB and the volume of operation required in processing one macro block as an invalid block is denoted by Ks. It is provided, however, that the volume of operation Ks required in processing the invalid macro block has a far smaller value than the volume of operation required for the ordinary process of one macro block and the same process is performed for the macro block of any of the frames. The means of invalidating blocks 9 calculates a time Ti for performing an interruption in accordance with the formula Ti=Tf×MB/F. The time for performing the interruption may be calculated by the means of deciding power-supply voltage, substrate bias voltage and operating frequency 3 mentioned above. Subsequently, the means of invalidating blocks 9 effects an interruption in the routine of encoding at the timing of the time T, reads out a number MBi (sign 117) of macro blocks which have undergone the process of encoding from a processed macro block number register 10, judges whether MBi=MB is satisfied or MBi<MB is satisfied, and decides whether or not the process of encoding has been completed. After satisfying MBi=MB which indicates that the process of encoding the present frame has been completed, the means of invalidating blocks 9 immediately terminates the interrupting routine and returns to the encoding routine. When MBi<MB which indicates that the process of encoding the present frame has not been completed is satisfied, the means of invalidating blocks 9 judges that the necessary operation volume calculated by the means of calculating necessary operation volume 2 is smaller than the actually necessary volume of operation, processes all the macro blocks remaining yet to be encoded as invalid blocks, and returns to the encoding routine. The failure situation can be avoided without fail because at least the volume of operation for processing all the macro blocks as invalid blocks has been secured by the point of time for effecting an interruption at the timing of the time Ti.

Incidentally, the failure situation may be avoided by using a process which comprises increasing the operating frequency of the processor 1 and adopting a substrate bias voltage and a power-supply voltage suitable for that operating frequency as specifically described herein below, in the place of the process of invalidating blocks. In this case, the interruption is effected with such timing that the time allocated in advance to the process of encoding the present frame allows a room enough for accomplishing the encoding of all the macro blocks remaining yet to be encoded.

(Proof 1) Now, the fact that the invention of the subject patent application is capable of decreasing the amount of electric power consumed by the subthreshold leakage current as compared with the conventional technique which encodes one frame while changing the operating frequency of the processor a plurality of times will be proved. It is assumed that the substrate bias voltage and the operating frequency of the processor 1 are varied in P steps, the necessary operation volume for any one frame is denoted by Kt, and the time allocated to that frame is denoted by Tt as shown in FIG. 5. The case of completing the process of a necessary operation volume Kt in a time Tt on the assumption that the operating frequency is set at Ft, the substrate bias voltage used in operating the processor 1 with the operating frequency Ft is denoted by Vb, and the threshold voltage suitable for the substrate bias voltage Vb is denoted by Vt as shown in FIG. 6(a) is labeled as Case 1 and the case of completing the process of the necessary operation volume Kt in a time T1+T2 on the assumption that the operating frequency of the initial value is set at h*Ft, the substrate bias voltage used in operating the processor with the operating frequency h*Ft is denoted by Vb1, the threshold voltage suitable for the substrate bias voltage Vb1 is denoted by Vt1, the operating frequency of the processor is changed to h*Ft/2 after the elapse of a time T1, the substrate bias voltage used in operating the processor 1 with the operating frequency h*Ft/2 is denoted by Vb2, and the threshold voltage suitable for the substrate bias voltage is denoted by Vt2 as shown in FIG. 6(b) is labeled as Case 2. Now, the case of encoding the aforementioned one arbitrary frame will be considered with respect to each of Case 1 and Case 2. It is provided, however, that the threshold voltages have the relation Vt1>Vt>Vt2 and the electric power consumed by the subthreshold leakage current is expressed by the following formula.
Pst=VDD×Iₒ×10ˆ(−Vt/S)
wherein Iₒ denotes a constant, VDD denotes a power-supply voltage, Vgs denotes a voltage between gate and source, Vt denotes a threshold voltage, and S denotes a subthreshold swing. When an electric power Pst1 consumed by the subthreshold leakage current of Case 1 and an electric power Pst2 consumed by the threshold leakage current of Case 2 are calculated in accordance with this formula; the following results are obtained.
Pst1=VDD×Iₒ×10ˆ(−Vt/S)×Tt
Pst2=VDD×Iₒ×10ˆ(−Vt1/S)×T1+Iₒ×10ˆ(−Vt2/S)×T2
Consequently, the following formula is satisfied.
Pst1:Pst2=10ˆ(−Vt/S)×Tt:(10ˆ(−Vt/S)×.T1+10ˆ(−Vt/S)×T2)
When h=1.5, Ta=1/3×Tt, T=2/3×Tt, Vt1=3×S, Vt=S, and Vt2=S, and Vt=2×S are assumed, for example, the relation Pst1<Pst2 is satisfied by the following formula.
Pst1:Pst2=10⁻²:(10⁻³/3+10⁻¹×2/3)≈0.01:0.07
Thus, it is seen that, though the volume of operation Kt is invariable when a fixed volume of operation is performed in a fixed time, the electric power consumption is smaller when the processor is operated with the smallest operating frequency that allows the process to be completed within the time while the substrate bias voltage thereof is fixed throughout the whole length of the processing time as in Case 1 than when the operating frequency is varied as observed conventionally during the course of the processing time as in Case 2. It is consequently evident that the present invention which performs the process of encoding one frame while operating the processor 1 with fixed substrate bias voltage and operating frequency promotes the decrease of power consumption as compared with the conventional technique which suffers the operating frequency to vary many times during the course of encoding one frame because the substrate bias voltage and the operating frequency are decided for each of the blocks.

(Proof 2)

Now, the fact that this invention is capable of promoting the decrease of power consumption as compared with the conventional technique which encodes one frame while suffering the power-supply voltage and the operating frequency of the processor to vary a plurality of times will be proved below. In the case of performing a specific volume Kt of operation within a specific time Tt, for example, the decrease of power consumption can be realized by performing the control with a fixed frequency throughout the whole length of the specific time and setting the frequency Ft according to the following formula.
Ft=Kt/Tt

The power-supply voltage and the operating frequency of the processor 1 are made variable in P steps as shown in FIG. 5, the necessary operation volume for one arbitrary frame is denoted by Kt, and the time allocated to the process of that frame is denoted by Tt, for example. The case of completing performance of a necessary operation volume Kt within a time Tt on the assumption that the operating frequency is set at Ft and the power-supply voltage used in operating the processor 1 with the operating frequency Ft is denoted by VDD (namely when the operating frequency is fixed) as shown in FIG. 7(a) is labeled as Case 1, and the case of completing performance of a necessary operation volume Kt within a time T1+T2 on the assumption that the operating frequency of the initial value is set at h*Ft, the power-supply voltage used in operating the processor with the operating frequency h*Ft is denoted by VDD1, the operating frequency of the processor is changed to h*Ft/2 after the elapse of the time T1, and the power-supply voltage in operating the processor with the operating frequency h*Ft/2 is denoted by VDD2 as shown in in FIG. 7(b) (namely the change of the operating frequency is carried out once) is labeled as Case 2. Now, the case of encoding the aforementioned one arbitrary frame will be considered with respect to each of Case 1 and Case 2. The two cases have one and the same volume of operation, Kt (cycles). Meanwhile, the electric power consumed is expressed as follows.
P=α×C×f×VDD²×t
wherein α denotes a coefficient, C denotes the number of transistors of the processor, f denotes an operating frequency, VDD denotes a power-supply voltage, and t denotes an operating time. When an electric power consumption Pa in Case 1 and an electric power consumption Pb in Case 2 are calculated in accordance with this formula, the following results are obtained.
Pa=α×C×Ft×VDD²×Tt
Pb=α×C×(h×Ft)×VDD1²×T1+α×C×(h×Ft/2)×VDD2²×T2
Consequently, the following formula is satisfied.
Pa:Pb=VDD²×Tt:(h×.VDD1²×T1+(h/2)×VDD2²×T2)
When h=1.5, T1=1/3×Tt, T2=2/3×Tt, VDD=1, VDD1=1.5, and VDD2=0.75 are assumed, for example, the relation Pa<Pb is satisfied by the following formula.
Pa:Pb=1²:(1.5×1.5²/3+(1.5/2)×0.75²×(2/3)≈1:1.41
Thus, it is seen that, though the volume of operation Kt is invariable when a fixed volume of operation is performed in a fixed time, the electric power consumption is smaller when the processor is operated with the smallest operating frequency that allows the process to be completed within the time while the substrate bias voltage thereof is fixed throughout the whole length of the processing time as in Case 1 than when the operating frequency is varied as observed conventionally during the course of the processing time as in Case 2. It is consequently evident that the present invention which performs the process of encoding one frame while operating the processor 1 with fixed power-supply voltage and operating frequency promotes the decrease of power consumption as compared with the conventional technique which suffers the power-supply voltage and the operating frequency to vary many times during the course of encoding one frame because the power-supply voltage and the operating frequency are decided for each of the blocks.

### Second Mode of Embodiment

FIG. 8 is a schematic block diagram illustrating the operation of the motion picture encoding system S2 of the second mode of embodiment. The motion picture encoding system S2 of the present mode of embodiment equals the motion picture encoding system S1 of the first mode of embodiment mentioned above except being provided as a second means of avoiding failure situation with a means of judging residual operation volume 29 in the place of the means of invalidating blocks 9 and the processed macro block number register 10. FIG. 9 is a diagram depicting a schematic flow chart of a motion picture encoding program Prg2 for that system. The program Prg2 enables the computer to function as the motion picture encoding system S2 furnished with various means. The time-varying encoding system S2, unlike the motion picture encoding system S1, is intended to solve the aforementioned problem by controlling the dynamic power-supply voltage, substrate bias voltage and operating frequency which are operating the processor 1 and/or the peripheral devices including the local decoding memory 6 and so on. Now, the control of the dynamic power-supply voltage, substrate bias voltage and operating frequency will be described in detail below.

The operating frequency, the power-supply voltage and the substrate bias voltage which serve the process for the present frame are calculated by the means of deciding power-supply voltage, substrate bias voltage and operating frequency 3 based on the value calculated by the means of calculating necessary operation volume 2. When the value of the calculated necessary operation volume Kp is smaller than the necessary operation volume Km actually necessitated for the process for the present frame, however, the operating frequency calculated based on the value of the necessary operation volume Kp is also smaller than the operating frequency actually necessary for the process of the present frame.

Then, the motion picture encoding system S2, similarly to the aforementioned motion picture S1, imparts regularly spaced interruptions in N times to the means of encoding motion picture 5, induces temporary interruptions in the encoding process and, at the points of time of these interruptions, causes the means of judging residual operation volume 29 to compare a residual operation volume Ki which is the residue of the necessary operation volume of the present frame calculated by the means of calculating necessary operation volume 2 with the residue of the volume of operation actually necessitated for the process of encoding a prescribed frame performed by the means of encoding motion picture 5. Specifically, in the i'th interruption, the means of judging residual operation volume 29 determines the residual time Ti allocated to the process of the present frame and the operating frequency F of the processor 1 and calculates the residual operation volume Ki in accordance with the formula Ki=Ti×F. The means of judging residual operation volume 29 preserves the first through (i−1)'th times of interruption T1, T2, . . . , T(i−1) and the operating frequencies F1, F2, . . . , F(i−1) of the processor at the points of time of the interruptions and calculates volumes of operation Kpm spent for the process of the present frame from the time of starting the process of the present frame till the time of occurrence of the i'th interruption in accordance with the formula Kpm=Σ{Fj×(T(j+1)−Tj)}using the aforementioned values. Fj denotes the operating frequency, j=0, 1, . . . , (i−1), of the processor set at the time of starting the process of the present frame. The means of judging residual operation volume 29 subsequently judges which of the formulas, Ki≧Kpm×(MB−MBi)/MBi and Ki<Kpm×(MB−MBi)/MBi), is satisfied. When the residual operation volume Ki found by calculation and the volume of operation Kpm spent for the process of the present frame satisfy the formula, Ki≧Kpm×(MB−MBi)/MBi, the process of interruption terminates and the encoding routine returns. The means of encoding motion picture 5 continues the process of the present frame till the time of occurrence of the (i+1)′th interruption. When the residual operation volume Ki found by calculation and the volume of operation Kpm spent for the process of the present frame satisfy the formula, Ki<Kpm×(MB−MBi)/MBi, the means of judging residual operation volume 29 judges that the necessary operation volume calculated by the means of calculating necessary operation volume 2 is smaller than the actually necessary operation volume and instructs the means of controlling power-supply voltage, substrate bias voltage and operating frequency 4 to raise by one step the operating frequency supported by the processor 1 and/or the peripheral devices including the local decoding memory 6 and so on shown in FIG. 5 and operate the processor 1 and/or the peripheral devices including the local decoding memory 6 and so on with the power-supply voltage and the substrate bias voltage conforming to the operating frequency (sign 104). Here, the instruction may be directed toward raising the operating frequency by two or more steps instead. Incidentally, MB denotes the total the number of macro blocks contained in the present frame and MBi denotes the number of encoded macro blocks of the present frame existing at the time of occurrence of the i'th interruption. Since the process described above enables the operating frequency of the processor to be raised halfway in the course of the process of the present frame, the process of the present frame can be terminated without entailing any failure situation even when the operating frequency set in the processor at the time of starting the process of the present frame happens to be smaller than the operating frequency necessitated in realizing the operation volume necessary for the process of the present frame. Incidentally, the number of points of time for interrupting the means of encoding motion picture 5 does not need to be limited to N and the N interruptions may be occurred at arbitrary intervals. It is permissible to use the formulas, Ki≧Kpm×(BL−BLi)/BLi and Ki≧Kpm×(BL−BLi)/BLi, in the place of the formulas, Ki<Kpm×(MB−MBi)/MBi and Ki<Kpm×(MB−MBi)/MBi. Here, BL denotes the total number of blocks contained in the present frame and BLi denotes the number of processed blocks of the present frame at the time of occurrence of the i'th interruption. Incidentally, the present system S2 may be provided with the first means of avoiding failure situation 11.

### Third Mode of Embodiment

The motion picture decoding system S3 of the third mode of embodiment of this invention is intended to decode a motion picture that has been encoded. FIG. 10 is a schematic block diagram illustrating the operation of the motion picture decoding system S3. The motion picture decoding system S3 of the present mode of embodiment is provided with the processor 1 having power-supply voltages and substrate bias voltages and operating frequencies prepared for r steps (r denoting an integer of not less than 2) and enabled to vary these power-supply voltages and substrate bias voltages and operating frequencies by a program, the means of controlling power-supply voltage, substrate bias voltage and operating frequency 4, a local decoding frame memory 36 for storing the decoded data of the previous frame, and a means of judging residual operation volume 39 adapted to operate on the processor 1. The local decoding memory 36 may have the power-supply voltage, substrate bias voltage and operating frequency controlled similarly to the processor 1 by the power-supply voltage, substrate bias voltage and operating frequency judging means 4. The processor 1 is provided with a means of calculating necessary operation volume 32 adapted to operate on the processor 1, the means of deciding power-supply voltage, substrate bias voltage and operating frequency 3, and a means of decoding motion picture 35 adapted to operate on the processor 1. The sign 301 denotes an input encoded data, sign 102 denotes a indicator of power-supply voltage, substrate bias voltage and operating frequency, the sign 105 denotes a supplier of power-supply voltage, substrate bias voltage and operating frequency, and the sign 306 denotes a decoded data, same signs found in the first mode of embodiment represent parts fulfilling identical or equivalent functions. The third mode of embodiment resembles the second mode of embodiment except the point of performing a decoding operation in the place of an encoding operation and the following points.

The operation of the motion picture decoding system S3 will be described below with reference to FIG. 10. The process for decoding the present frame will be explained below on the assumption that one arbitrary frame selected from the successive frames to be decoded (namely the frame to be decoded subsequently based on the point of time at which a certain frame has been decoded, ie the frame which has not been decoded by that point of time and is expected to be subjected to the process of decoding in the future) is named a present frame and one frame decoded prior to the present frame (the frame decoded in the past) is named a previous frame. The same process is performed for any of the frames. A motion picture decoding program Prg3 for causing the computer to function as the motion picture decoding system S3, though nearly the same as the aforementioned motion picture encoding program Prg1, causes the computer (specifically the processor 1 built in the computer) to function as the means of decoding motion picture 35 adapted to decode the encoded data of the present frame. The input decoded data 301 which inputs into the motion picture decoding system S3 is input into the means of calculating necessary operation volume 32. The means of calculating necessary operation volume 32 calculates a volume of generated data (the number of bits) of one-frame portion of the encoded data 301 (namely the encoded data 301 of the present frame) and carries out a calculation for estimating the volume Kp of necessary calculation (the step of calculating necessary operation volume). The volume Kp of necessary operation is expressed by the following formula.
Kp=G(FB, MVa, MVv, B, C, BR, Q, ΔQ, I, E, P)
wherein FB denotes the number of bits of the encoded data of the present frame or the previous frame, MVa denotes the average value of the size of the moving vector of the present frame or the previous frame, MVv denotes the dispersion of the size of the moving vector of the present frame or the previous frame, B denotes the number of valid blocks of the present frame or the previous frame, C denotes the number of valid coefficients of the present frame or the previous frame, BR denotes the bit rate of the present frame or the previous frame, Q denotes the average value of the quantizing step size of the present frame or the previous frame, AQ denotes the difference of the average values of the quantizing step sizes of the present frame and the previous frame or the difference of the average values of the quantizing step sizes of the previous frame and the frame directly before the previous frame, I denotes the kind of the present frame as to discrimination among an I picture, a P picture, and a B picture, E denotes the volume of operation required for decoding the previous frame, and P denotes the necessary operation volume of the previous frame calculated by the means of calculating necessary operation volume.

Now, the aforementioned function G will be explained below. The volume of operation required for decoding the present frame depends on the numbers of times of IDCT process, IQ process, and VLD process executed in decoding the present frame. The number of times of IDCT process executed depends on the number of valid blocks contained in the present frame and the numbers of times of IQ process and VLD process executed depend on the number of valid coefficients contained in the present frame. That is, the volume of operation necessary for the process of decoding becomes large (small) when the number of valid blocks and the number of coefficients contained in the present frame is large (small). The function G mentioned above, therefore, is formed so as to set Kp at a large (small) value when B and C are large (small).

When the image produces a large (small) change between the previous frame and the present frame, the average value MVa of the size of the moving vector and the dispersion MVv of the size of the moving vector become large (small). At this time, the number of valid blocks and the number of coefficients of the present frame become large (small) and the volume of operation necessary for the process of encoding becomes large (small). The function G mentioned above, therefore, is formed so as to set Kp at a large (small) value when MVa and MVv are large (small).

When the present frame consists of an I picture, the volume of operation necessary for the process of decoding becomes small because the addition of an estimated image and a differential image otherwise required in forming a decoded data does not need to be made. The function G mentioned above, therefore, is formed so as to set Kp at a small value when the present frame consists of an I picture.

When the number FB of bits and the frame rate BR of the encoded data are large (small), the number of valid blocks and the number of valid coefficients become large (small). The function G mentioned above, therefore, is formed so as to set Kp at a large (small) value when FB and BR are large (small). Since the quantizing step size has the value thereof vary during the control of the bit rate, the Kp which the aforementioned function G calculates can be made to approach closely to the volume of operation actually necessitated for decoding the present frame by taking into consideration the average value Q of the quantizing step size and the difference AQ in the average values of the quantizing step size.

Since the motion picture has a large correlation among the successive frames, MVa, MVv, B, C, BR, FB, and Q severally assume closely approximating values between the present frame and the previous frame. When these parameters are used in the function G mentioned above, therefore, the values involved in the present frame may be used or the values involved in the previous frame may be used. When the values involved in the present frame are used, the input encoded data is received, the data is partly decoded, and the resultant value is withdrawn and put to use. At this time, the use of the values derived from the present frame brings a merit of enabling the estimated necessary operation volume Kp to approximate more closely to the volume of operation actually necessary for the process of decoding. The use of the values derived from the previous frame brings a merit of enabling the process of decoding to be performed on only the received portion of data while continuing the reception of the input encoded data because the estimated necessary operation volume Kp can be calculated before the input encoded data of the present frame is received.

Furthermore, since the motion picture has a large correlation among the successive frames, the volume of operation necessary for the process of decoding the present frame assumes a value approximating closely to the volume of operation E which was actually necessary for the process of decoding the previous frame. Besides, the relation P≈E is satisfied when the necessary operation volume estimated by the means of calculating necessary operation volume assumes a value approximating closely to the volume of operation actually required for the process of decoding. By taking into consideration E and P, therefore, the Kp which the function G mentioned above calculates is enabled to assume a value approximating closely to the volume of operation actually necessary for decoding the present frame.

In the means of calculating necessary operation volume 32, only one of these important factors may be used or a plurality of such important factors may be used in combination. To be specific, since the plurality of important factors affect the necessary operation volume for the process of decoding the present frame, the necessary operation volume Kp calculated by the means of calculating necessary operation volume 32 is enabled to assume a value approximating closely to the volume of operation actually used for the process of decoding by causing the means of calculating necessary operation volume 32 to carry out a computation such that the necessary operation volume Kp (cycle) may be increased or decreased in conformity with these important factors.

The means of calculating power-supply voltage, substrate bias voltage and operating frequency 3 (the step of deciding power-supply voltage, substrate bias voltage and operating frequency) and the means of controlling power-supply voltage, substrate bias voltage and operating frequency 4 equal to those used in the aforementioned first mode of embodiment. The means of decoding motion picture 35 decodes the input encoded data 301 of the present frame and produces a decoded data 306 (the step of decoding motion picture). When the means of decoding motion picture 35 implements the process for decoding, the means of controlling power-supply voltage, substrate bias voltage and operating frequency 4 is relied on to carry out the process of decoding while keeping the processor 1 operated with fixed power-supply voltage and substrate bias voltage and operating frequency. For each of the frames, the necessary operation volume is calculated prior to the process of decoding the relevant frame and the decoding of the frame is carried out while the operation of the processor is continued with the fixed operating frequency and power-supply voltage and substrate bias voltage. This procedure, therefore, is capable of promoting the decrease of power consumption as compared with the conventional technique that suffers the operating frequency and the power-supply voltage to vary for each prescribed number of blocks resulting from dividing a frame. The decoded data 306 is displayed as a motion picture on the image display part of a portable telephone or a personal computer or stored in such a memory medium as a hard disk.

The motion picture decoding system S3 is also provided as a second means of avoiding failure situation with the means of judging residual operation volume 39. While the means of judging residual operation volume 39 is nearly equal to that of the aforementioned second mode of embodiment, it is different from it in respect that it serves to judge not the volume of operation of the process of encoding but the volume of operation of the process of decoding. By the means of judging residual operation volume 39, it is made possible to avoid the failure situation. The motion picture decoding system S3, similarly to that of the aforementioned first mode of embodiment, may be provided with the first means of avoiding failure situation. Incidentally, no process of invalidating blocks is carried out in the process of decoding.

The motion picture encoding system of this invention may be provided with the first means of avoiding failure situation 11, the means of invalidating blocks 9 as the second means of avoiding failure situation, and the means of judging residual operation volume 29 and 39 as the second means of avoiding failure situation independently of one another. Otherwise, it may be provided with these means as suitably combined. When the system is not enabled to avoid the failure situation even by providing the system with the first and both of the second means of avoiding failure situation altogether and inducing the first means of avoiding failure situation 11 to increase the necessary operation volume, the failure may be overcome by causing the means of judging residual operation volume 29 and 39 as the second means of avoiding failure situation to increase the operating frequency and allowing the system to operate with the power-supply voltage and the substrate bias voltage suitable for the increased operating frequency. When the failure persists even if the failure situation is avoided, the failure situation may be suppressed by causing the means of invalidating blocks 9 serving as the second means of avoiding failure situation to facilitate the process of encoding. The aforementioned motion picture encoding/decoding program may be realized with the hardware that is endowed with the same function as the program.

### Fourth Mode of Embodiment

While the aforementioned first through third modes of embodiment are intended to control the power-supply voltage, substrate bias voltage, and operating frequency, the present mode of embodiment is directed toward promoting the decrease of power consumption by controlling the substrate bias voltage and the operating frequency. FIG. 11 is a schematic block diagram illustrating the operation of a motion picture encoding system S4 and FIG. 12 is a conceptual diagram showing the relation between the substrate bias voltage and the operating frequency of a processor 41. The motion picture encoding system S4 of the present mode of embodiment utilizes, in the place of the processor 1 of the aforementioned first mode of embodiment, a processor 41 which is capable of varying the substrate bias voltages Vbn and Vbp and the operating frequency in r steps (r denoting an integer of not less than 2, namely, capable of operating with r steps of substrate bias voltages Vbn and Vbp and operating frequency) and capable of having the substrate bias voltage and the operating frequency varied by a program. It further utilizes, in the place of the aforementioned means of controlling power-supply voltage, substrate bias voltage and operating frequency 4, a means of controlling substrate bias voltage and operating frequency 44 which functions to control the substrate bias voltage and the operating frequency of the processor 1. The processor 1 or the processor 1 and the peripheral devices (including the local decoding memory 6 and the input frame memory 7 and so on) have the substrate bias voltage and the operating frequency thereof controlled by a means of controlling substrate bias voltage and operating frequency 42.

A means of deciding substrate bias voltage and operating frequency 43 performs a calculation for selecting the operating frequency F(n) satisfying F(n)>Fe and F(n−1)<Fe as well as the operating frequency for effecting the process of encoding the present frame, performs a calculation for selecting substrate bias voltages Vbn(n) Vbp(n) suitable for the operating frequency F(n), and instructs the means of controlling substrate bias voltage-operating frequency 44 of the substrate bias voltage and operating frequency so as to have the processor 1 and/or the peripheral devices including the local decoding memory 6 and so on operate with the operating frequency F(n) and the substrate bias voltages Vbn(n) and Vbp(n) (sign 402). The means of controlling substrate bias voltage and operating frequency 44 supplies the processor 1 and/or the peripheral devices including the local decoding memory 6 and so on with the values of the substrate bias voltages Vbn(n) and Vbp(n) and the operating frequency F(n) received from the means of calculating substrate bias voltage and operating frequency 43 (sign 405) and effects a control such that the processor 1 may be steadily operated with the substrate bias voltages Vbn(n) and Vbp(n) and the operating frequency F(n). As a result, the processor 1 and/or the peripheral devices including the local decoding memory 6 and so on are enabled to operate with the fixed substrate bias voltages Vbn(n) and Vbp(n) and operating frequency F(n). The other points of the present mode of embodiment nearly equal those of the first mode of embodiment.

The second mode of embodiment and the third mode of embodiment may each constitute a system for controlling the substrate bias voltage and the operating frequency without controlling the power-supply voltage. When they are furnished with a means of judging residual operation volume (not shown), they instruct the means of controlling substrate bias voltage and operating frequency 44 to raise by one step the operating frequency supported by the processor 1 and/or the peripheral devices including the local decoding memory 6 and so on shown in FIG. 12 and enable the processor 1 and/or the peripheral devices including the local decoding memory 6 and so on to operate steadily with the substrate bias voltage conforming to the resultant operating frequency.

### EXAMPLE 1

Example 1 concerning the motion picture encoding system S1 of the first mode of embodiment will be explained below. For this explanation, a motion picture data consisting of 75 frames was used and the 32^{nd} frame was selected as an example of the frame to be encoded. The frames were each formed of 144 lines and 176 rows of picture elements. For the process of encoding, MPEG4 was used. FIG. 13 shows an example of the relation among the operating frequency, power-supply voltage, and substrate bias voltage in the processor 1 of the motion picture encoding system S1. The processor 1 of the motion picture encoding system S1 had an operating frequency F in the range of 50 MHz-250 MHz, a power-supply voltage VDD in the range of 0.5V-1.0V, and substrate bias voltages Vbn and Vbp in the respective ranges of −1.0V-0.5V and 1.5V-0.5V, which were severally variable in 5 steps.

First, the motion picture encoding system S1 gained access to the input frame memory 7, acquired the 31^{st} frame, and calculated the necessary operation volume Kp of that frame through the medium of the means of calculating necessary operation volume 2. The necessary operation volume Kp specifically resulted from calculating a total absolute differential value Z in accordance with the following formula using the 30^{th} frame as the previous frame.
Z=Σ|Xij−Yij|=50705

Subsequently, an amount of activity W of the 31^{st} frame as the present frame was calculated in accordance with the following formula.
Horizontal direction Wh=Σ|X(i,j)−X(1,j)|=137412
Vertical direction Wv==Σ|X(i,j)−X(i,j−1)|=109176

Further, the number of macro-block matching of the previous frame M=102, the average quantizing step size (the average value of quantizing step size) of the previous frame Qprev=3, the number of valid blocks of the previous frame B=98, the number of valid coefficients of the previous frame C=610, the amount of operation actually necessitated for encoding the previous frame S=10022474, and the encoding bit rate of the present frame BR=65536 were obtained. The difference between the average value of the quantizing step size of the previous frame and the average value of the quantizing step size of the 20^{th} frame immediately before the previous frame ΔQprev=0 was calculated. The number of bits actually generated in the previous frame D=56797 was also obtained. Subsequently, the necessary operation volume Kp was calculated in accordance with the following formula using the relevant important factors.
Kp=j+αM+βB+γC+δZ+εQprev

Thus, the necessary operation volume Kp=10315571 was obtained in the present Example 1.

Further, a calculation for increasing the necessary operation volume Kp was carried out in accordance with the following formula using the aforementioned necessary operation volume Kp=10315571 calculated from the relevant important factors. In the following explanation, the case of using the aforementioned formula Kp=G(Z)×m was cited as an example.
Kpf=10315571×1.1=11347129

Next, the operating frequency was calculated in accordance with the following formula.
Fe=Kpf/Te=11347129/(1/15)=171 MHz
By calculating F(n) satisfying F(n)>Fe and F(n−1)<Fe as well, the operating frequency F(4)=200 MHz was selected from among the operating frequencies of the processor 1 variable in 5 steps and the power-supply voltage VDD(4)=0.9V and the substrate bias voltages Vbn(4)=0.2V and Vbp(4)=0.7V conforming to the operating frequency were selected. The means of controlling power-supply voltage, substrate bias voltage and operating frequency 4 was so instructed that at least the processor 1 might be operated with the operating frequency F=200 MHz and the power-supply voltage VDD=0.9V and the substrate bias voltages Vbn=0.2V and Vbp=0.7V. The means of controlling power-supply voltage, substrate bias voltage and operating frequency 4 performed a control for enabling at least the processor 1 to operate steadily with the operating frequency F=200 MHz and the power-supply voltage VDD=0.9V and the substrate bias voltages Vbn=0.2V and Vbp=0.7V. The means of encoding motion picture 5 acquired a frame F from the input frame memory 7 and performs a process of encoding and form an encoded data by using the processor 1 in a state of being operated steadily with the operating frequency F=200 MHz and the power-supply voltage VDD=0.9V and the substrate bias voltages Vbn=0.2V and Vbp=0.7V mentioned above.

Furthermore, the means of invalidating blocks 9, while executing an encoding routine, calculated the time for interruption in accordance with the following formula and effected the interruption.

$$\begin{matrix}Ti = Tf - Ks \times MB / F \\ = 0.06666 - 37 \times 99 / ( 200000000 ) \\ \approx 0.06664\end{matrix}$$

Further, the means of invalidating blocks 9 judged whether or not Mbi<MB was satisfied at the timing of this interruption. In the present Example 1, since MBi<MB was satisfied and the process of encoding the present frame was not completed at the timing of Ti=0.06664, all the remaining macro blocks were treated as invalid blocks and the encoding routine was resumed. Here, Ks stands for the number of cycles required for processing one macro block as an invalid block.

### EXAMPLE 2

Example 2 concerning the motion picture encoding system S2 of the second mode of embodiment will be explained. Example 2 presumed to carry out four interruptions in the process of encoding. The means of judging residual operation volume 29 calculated Ki=Ti×F and Kpm=ΣFj×(T(j+1)−Ti) during the first and the second interruption, further calculated Kpm×(MB−MBi) as the residue of the actually necessary volume of operation, and judged which of the formulas, Ki≧Kpm×(MB−MBi)/MBi and Ki<Kpm×(MB−MBi)/MBi, was satisfied. In the present Example 2, since K1≧Kpm×(MB−MB1)/MB1 and K2≧Kpm×(MB−MB2)/MB2 were satisfied, the process of interruption was terminated and the means of encoding motion picture 5 continued the process of encoding till the third interruption. These calculation and judgment were carried out similarly during the third interruption was the subsequent interruption. In the present Example 2, since K3<Kpm×(MB−MB3)/MB3 was satisfied, the means of controlling power-supply voltage, substrate bias voltage and operating frequency 4 was instructed to use the frequency F(5)=250 MHz and the voltages VDD(5)=1.0V, Vbn(5)=0.5V, and Vbp(5)=0.5V resulting from raising by one step the operating frequency and the power-supply voltage and the substrate bias voltage respectively as the operating frequency and the power-supply voltage and the substrate bias voltage.

1. A motion picture encoding/decoding system incorporating a means of encoding/decoding motion picture for sequentially encoding/decoding a motion picture in the unit of frame formed of a plurality of successive frames by the use of a processor implemented with MOS transistors laminated on a semiconductor substrate and enabling the processor to control an operating frequency and a substrate bias voltage, which system is characterized by comprising a means of calculating necessary operation volume for calculating the volume of operation necessary for encoding/decoding the present frame and a means of deciding substrate bias voltage and operating frequency for deciding an operating frequency capable of encoding/decoding the volume of necessary operation within a time allocated in advance to the process for encoding/decoding the present frame and for deciding a substrate bias voltage suitable for the operating frequency and permitting the processor to operate steadily in the unit of frame with the substrate bias voltage and the operating frequency decided by the means of deciding substrate bias voltage-operating frequency while causing the means of encoding/decoding motion picture to perform the process of encoding/decoding the present frame.

2. A motion picture encoding/decoding system incorporating a means of encoding/decoding motion picture for sequentially encoding/decoding in the unit of frame a motion picture formed of a plurality of successive frames by the use of a processor implemented with MOS transistors laminated on a semiconductor substrate and enabling the processor to control an operating frequency and a substrate bias voltage and a power-supply voltage, which system is characterized by comprising a means of calculating necessary operation volume for calculating the volume of operation necessary for encoding/decoding the present frame and a means of deciding power-supply voltage, substrate bias voltage and operating frequency for deciding an operating frequency capable of encoding/decoding the volume of necessary operation within a time allocated in advance to the process for encoding/decoding the present frame and for deciding a power-supply voltage and a substrate bias voltage suitable for the operating frequency and permitting the processor to operate steadily in the unit of frame with the substrate bias voltage, the power-supply voltage, and the operating frequency decided by the means of deciding power-supply voltage, substrate bias voltage and operating frequency while causing the means of encoding/decoding motion picture to perform the process of encoding/decoding the present frame.

3. A motion picture encoding/decoding system according to claim 1, wherein the processor allows the operating frequency thereof to vary in r steps (r denoting an integer of not less than 2) and the means of deciding substrate bias voltage-frequency calculates the operating frequency Fe necessary for processing the necessary operation volume Kp with the time Te by the formula Fe=Kp/Te using the necessary operation volume Kp of the present frame calculated by the means of calculating necessary operation volume and the time Te allocated to the processing of the present frame, selects from the operating frequencies available for the operation of the processor an operating frequency exceeding the necessary operating frequency Fe mentioned above and approximating most closely to the operating frequency Fe, and decides a substrate bias voltage suitable for the selected operating frequency.

4. A motion picture encoding/decoding system according to claim 2, wherein the processor allows the operating frequency thereof to vary in r steps (r denoting an integer of not less than 2) and the means of deciding power-supply voltage, substrate bias voltage and operating frequency calculates the operating frequency Fe necessary for processing the necessary operation volume Kp with the time Te by the formula Fe=Kp/Te using the necessary operation volume Kp of the present frame calculated by the means of calculating necessary operation volume and the time Te allocated to the processing of the present frame, selects from the operating frequencies available for the operation of the processor an operating frequency exceeding the necessary operating frequency Fe mentioned above and approximating most closely to the operating frequency Fe, and decides a power-supply voltage and a substrate bias voltage suitable for the selected operating frequency.

5. A motion picture encoding/decoding system according to claim 1, which is provided with a means of avoiding failure situation for avoiding the failure situation which occurs when the necessary operation volume calculated by the means of calculating necessary operation volume is smaller than the actually necessary volume of operation.

6. A motion picture encoding/decoding system according to claim 5, which is provided as the means of avoiding failure situation with a first means of avoiding failure situation for enabling the necessary operation volume calculated by the means of calculating necessary operation volume to be increased by a prescribed value.

7. (canceled)

8. A motion picture encoding/decoding system according to claim 5, which is provided as the means of avoiding failure situation with a second means of avoiding failure situation for judging whether or not the necessary operation volume calculated by the means of calculating necessary operation volume is smaller than the volume of operation actually necessary for the process of encoding/decoding performed by the means of encoding/decoding motion picture and, when the calculated volume of operation is judged to be smaller, performing a process for avoiding the failure situation.

9. A motion picture encoding system according to claim 8, which is provided as the second means of avoiding failure situation at least with a means of invalidating blocks for interrupting the process of encoding with the means of encoding motion picture at a prescribed timing and, when a macro block which has escaped the encoding is detected, effecting a block invalidating process on the macro block.

10. A motion picture encoding/decoding system according to claim 8, which is provided as the second means of avoiding failure situation at least with a means of judging residual operation volume interrupting the process of encoding/decoding performed by the means of encoding/decoding motion picture at a prescribed timing and, when the residue of the necessary operation volume of the present frame calculated by the means of calculating necessary operation volume is smaller at the time of the interruption than the residue of the volume of operation actually necessary for the process of encoding/decoding the present frame performed by the means of encoding/decoding, increasing the operating frequency of the processor, and operating the processor with a substrate bias voltage suitable for the operating frequency.

11. A motion picture encoding/decoding system according to claim 8, which is provided as the second means of avoiding failure situation at least with a means of judging residual operation volume interrupting the process of encoding/decoding performed by the means of encoding/decoding motion picture at a prescribed timing and, when the residue of the necessary operation volume of the present frame calculated by the means of calculating necessary operation volume is smaller at the time of the interruption than the residue of the volume of operation actually necessary for the process of encoding/decoding the present frame performed by the means of encoding/decoding, increasing the operating frequency of the processor, and operating the processor with a power-supply voltage and a substrate bias voltage suitable for the operating frequency.

12. (canceled)

13. (canceled)

14. A motion picture encoding/decoding method for sequentially encoding/decoding in the unit of frame a motion picture formed of a plurality of successive frames by the use of a processor implemented with MOS transistors laminated on a semiconductor substrate and enabling the processor to control an operating frequency and a substrate bias voltage, which method is characterized by comprising a step of calculating necessary operation volume for calculating the volume of operation necessary for encoding/decoding the present frame and a step of deciding substrate bias voltage and operating frequency for deciding a operating frequency capable of encoding/decoding the volume of necessary operation within a time allocated in advance to the process for encoding/decoding the present frame and for deciding a substrate bias voltage suitable for the operating frequency, and a step of encoding/decoding motion picture for permitting the processor to operate steadily in the unit of frame with the substrate bias voltage and the operating frequency decided in the substrate bias voltage-operating frequency deciding step while performing the process for encoding/decoding the present frame.

15. A motion picture encoding/decoding method for sequentially encoding/decoding in the unit of frame a motion picture formed of a plurality of successive frames by the use of a processor implemented with MOS transistors laminated on a semiconductor substrate and enabling the processor to control an operating frequency, a substrate bias voltage, and a power-supply voltage, which method is characterized by comprising a step of calculating necessary operation volume for calculating the volume of operation necessary for encoding/decoding the present frame and a step of deciding power-supply voltage, substrate bias voltage and operating frequency for deciding an operating frequency capable of encoding/decoding the volume of necessary operation within a time allocated in advance to the process for encoding/decoding the present frame and for deciding a power-supply voltage and a substrate bias voltage suitable for the operating frequency, and a step of encoding/decoding motion picture for permitting the processor to operate steadily in the unit of frame with the power-supply voltage, the substrate bias voltage, and the operating frequency decided in the step of deciding power-supply voltage, substrate bias voltage and operating frequency while performing the process for encoding/decoding the present frame.

16. A motion picture encoding/decoding method according to claim 14, wherein the processor allows the operating frequency thereof to vary in r steps (r denoting an integer of not less than 2) and the step of deciding substrate bias voltage and operating frequency calculates the operating frequency Fe necessary for processing the necessary operation volume Kp with the time Te by the formula Fe=Kp/Te using the necessary operation volume Kp of the present frame calculated by the means of calculating necessary operation volume and the time Te allocated to the processing of the present frame, selects from the operating frequencies available for the operation of the processor an operating frequency exceeding the necessary operating frequency Fe mentioned above and approximating most closely to the operating frequency Fe, and decides a substrate bias voltage suitable for the selected operating frequency.

17. A motion picture encoding/decoding method according to claim 15, wherein the processor allows the operating frequency thereof to vary in r steps (r denoting an integer of not less than 2) and the step of deciding power-supply voltage, substrate bias voltage and operating frequency calculates the operating frequency Fe necessary for processing the necessary operation volume Kp with the time Te by the formula Fe=Kp/Te using the necessary operation volume Kp of the present frame calculated by the step of calculating necessary operation volume and the time Te allocated to the processing of the present frame, selects from the operating frequencies available for the operation of the processor an operating frequency exceeding the necessary operating frequency Fe mentioned above and approximating most closely to the operating frequency Fe, and decides a power-supply voltage and a substrate bias voltage suitable for the selected operating frequency.

18. A motion picture encoding/decoding method according to any of claim 14, which is provided with a step of avoiding failure situation for avoiding the failure situation which occurs when the necessary operation volume calculated by the step of calculating necessary operation volume is smaller than the actually necessary volume of operation.

19. A motion picture encoding/decoding method according to claim 18, which is provided as the step of avoiding failure situation with a first step of avoiding failure situation for enabling the necessary operation volume calculated by the step of calculating necessary operation volume to be increased by a prescribed value.

20. (canceled)

21. A motion picture encoding/decoding method according to claim 18, which is provided as the step of avoiding failure situation with a second step of avoiding failure situation for judging whether or not the necessary operation volume calculated by the step of calculating necessary operation volume is smaller than the volume of operation actually necessary for the process of encoding/decoding performed by the means of encoding/decoding motion picture and, when the calculated volume of operation is judged to be smaller, performing a process for avoiding the failure situation.

22. A motion picture encoding method according to claim 21, which is provided as the second step of avoiding failure situation at least with a step of invalidating blocks for interrupting the process of encoding with the step of encoding motion picture at a prescribed timing and, when a macro block which has escaped the encoding is detected, effecting a block invalidating process on the macro block.

23. A motion picture encoding/decoding method according to claim 21, which is provided as the second step of avoiding failure situation at least with a step of judging residual operation volume interrupting the process of encoding/decoding performed by the motion picture step of encoding/decoding at a prescribed timing and, when the residue of the necessary operation volume of the present frame calculated by the step of calculating necessary operation volume is smaller at the time of the interruption than the residue of the volume of operation actually necessary for the process of encoding/decoding the present frame performed by the step of encoding/decoding, increasing the operating frequency of the processor, and operating the processor with a substrate bias voltage suitable for the operating frequency.

24. A motion picture encoding/decoding method according to claim 21, which is provided as the second step of avoiding failure situation at least with a step of judging residual operation volume interrupting the process of encoding/decoding performed by the motion picture step of encoding/decoding at a prescribed timing and, when the residue of the necessary operation volume of the present frame calculated by the step of calculating necessary operation volume is smaller at the time of the interruption than the residue of the volume of operation actually necessary for the process of encoding/decoding the present frame performed by the step of encoding/decoding, increasing the operating frequency of the processor, and operating the processor with a power-supply voltage and a substrate bias voltage suitable for the operating frequency.

25. (canceled)

26. (canceled)
